(19) United States
(12) Patent Application Publication
(10) Pub. No.: US 2016/0148507 A1
(43) Pub. Date: May 26, 2016

(54) TRAFFIC SYSTEM FOR MONITORING, ANALYZING, AND MODULATING TRAFFIC PATTERNS

(71) Applicant: Blyncsy, Inc., Salt Lake City, UT (US)

(72) Inventors: Mark Eric Pittman, Salt Lake City, UT (US); Patrick Barry Brown, Salt Lake City, UT (US)

(21) Appl. No.: 14/947,388

(22) Filed: Nov. 20, 2015

Related U.S. Application Data
(60) Provisional application No. 62/082,212, filed on Nov. 20, 2014.
(60) Provisional application No. 62/127,638, filed on Mar. 3, 2015.
(60) Provisional application No. 62/197,462, filed on Jul. 27, 2015.
(60) Provisional application No. 62/197,464, filed on Jul. 27, 2015.

(51) Int. Cl. G08G 1/095; G08G 1/07

(52) U.S. Cl. CPC G08G 1/095; G08G 1/07

(57) ABSTRACT

A signal tracker can include: a housing; at least two signal detectors in the housing; a computing component in the housing and operably coupled with the at least two signal detectors so as to obtain signal data therefrom; a memory device in the housing communicatively coupled with the computing component so as to receive the signal data and store the signal data thereon; and a transmitter in the housing communicatively coupled with the computing component so as to be capable of transmitting the signal data to a network. The signal tracker can include one or more of the listed components. The housing can be a weatherproof housing. The signal tracker can include the at least two signal detectors being selected from the group consisting of a cellular detector, a Wi-Fi detector, or a Bluetooth detector.

### CROSS-REFERENCE

This patent application claims benefit of: U.S. Provisional No. 62/082,212 filed on Nov. 20, 2014; U.S. Provisional No. 62/127,638 filed on Mar. 3, 2015; U.S. Provisional No. 62/197,462 filed on Jul. 27, 2015; and U.S. Provisional No. 62/197,464 filed Jul. 27, 2015, which provisional applications are incorporated herein by specific reference in their entirety.

### BACKGROUND

Tracking devices that can detect signals emitted from a mobile computing device can be used for tracking people that carry the devices. The ability to track the movement of people by using their mobile devices can provide valuable information about the patterns of their movement, commutes, and locations they visit. Such information can be processed to determine information based on trends in the tracked data. Now that the tracking data can be acquired, the applications for analysis of the data and use of the data can be explored.

### SUMMARY

In one embodiment, a signal tracker can include: a housing; at least two signal detectors in the housing; a computing component in the housing and operably coupled with the at least two signal detectors so as to obtain signal data therefrom; a memory device in the housing communicatively coupled with the computing component so as to receive the signal data and store the signal data thereon; and a transmitter in the housing communicatively coupled with the computing component so as to be capable of transmitting the signal data to a network or other signal receiver. The signal tracker can include one or more of the components provided herein. The housing can be a weatherproof housing. The signal tracker can include the at least two signal detectors being selected from the group consisting of a cellular detector, a Wi-Fi detector, or a Bluetooth detector. The signal tracker can include a receiver in the housing communicatively coupled with the computing component so as to be capable of receiving data from a network or from the cellular data, Wi-Fi data or Bluetooth data.

In one embodiment, a traffic light can include: at least one light emitter that is configured to emit a traffic signal light; and the signal tracker of one of the embodiments, the at least one light emitter being in the housing and having the light emitter directed out of the housing to emit traffic signal light. The at least one light emitter can include one or more of: a red light emitter, yellow light emitter, and a green light emitter; a computing component configured to execute a traffic light pattern with the at least one light emitter; or a receiver that is configured to receive traffic light pattern data from a traffic light controller. The traffic light can include: an electronic component having a first electronic coupling member; and the signal tracker having a second electronic coupling member that removably couples with the first electronic coupling member. The light emitter may be a multi-bulb emitter or screen emitter.

In one embodiment, a street light can include: at least one light emitter that is configured to emit illuminating light (e.g., white light or other street light); and the signal tracker of one of the embodiments, the at least one light emitter being in the housing and having the light emitter directed out of the housing to emit illuminating light.

In one embodiment, a cross-walk light can include: at least one light emitter that is configured to emit a cross-walk signal light; and the signal tracker of one of the embodiments, the at least one light emitter being in the housing and having the light emitter directed out of the housing to emit cross-walk light. The light emitter may be a multi-bulb emitter or screen emitter.

In one embodiment, a traffic light can include: a display screen that is configured to emit traffic signal information as a light image; a computer processor operably coupled with the display screen so as to provide the traffic signal information; a memory device operably coupled with the computer processor and having computer-executable code for causing the display screen to display traffic control information; and the signal tracker of one of the embodiments operably coupled with the computer processor, the display screen being in the housing to emit the traffic signal information out of the housing, the computer processor and memory device in the housing. The traffic light can include a receiver that is configured to receive traffic light pattern data from a traffic light controller. The traffic light can include: an electronic component having a first electronic coupling member in the housing; and the signal tracker having a second electronic coupling member that removably couples with the first electronic coupling member. The traffic light can include a plurality of display screens, each being configured to emit traffic signal information as a light image. The traffic light can include a receiver in the housing communicatively coupled with the computing component so as to be capable of receiving data from a network or from the cellular data, Wi-Fi data or Bluetooth data.

In one embodiment, a traffic modulation system can include: a plurality of signal trackers of the embodiments; a server computing system communicatively coupled to the plurality of signal trackers through a network; a plurality of traffic lights; and a traffic light controller communicatively coupled with the server computing system and the plurality of traffic lights so that the traffic light controller can receive traffic light pattern data from the server computing system and implement the traffic light pattern data to modulate the traffic light pattern of the plurality of traffic lights. In one aspect, the server computing system has a memory device with computer-executable code for receiving traffic data from the plurality of signal trackers and processing the traffic data to determine traffic light pattern data.

In one embodiment, travel data can be used to determine when a likely MCD will arrive at a given location. As such, the travel data can be analyzed to predict when and where a traveler (e.g., via the MCD) will arrive after traveling. Such a prediction can be based on the travel route and travel route historical data. Also, a given location and time can be identified, and a traveler likely to arrive at that given location and time can be identified, as well as groups of such travelers. The travel data can be analyzed in such a way that habits and travel patterns that are repeated can be used to make predictions of travel routes, travel times, time leaving origination location, location of origination location, time of arrival at destination, and destination location, among other parameters.

The foregoing summary is illustrative only and is not intended to be in any way limiting. In addition to the illustrative aspects, embodiments, and features described above, further aspects, embodiments, and features will become apparent by reference to the drawings and the following detailed description.

### DESCRIPTION OF FIGURES

The foregoing and following information as well as other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1A shows an embodiment of a system that includes a mobile computing device (MCD), signal tracker, network, and server computing system.

FIG. 1B shows an embodiment of a signal tracker that can be used to detect signals of MCDs.

FIG. 1C shows an embodiment of traffic monitoring and analysis system that includes a plurality of MCDs in proximity with a signal tracker, and a plurality of signal trackers communicatively coupled through a network to a Server Computing System (SCS).

FIGS. 1D-1 and 1D-2 shows an embodiment of an operation al protocol with the system of FIG. 1C.

FIG. 2 shows a map having a schematic representation of a plurality of signal trackers of a signal tracker system being deployed along a highway system of a geographical area, where the signal trackers are distributed in a manner to track MCDs, which are shown by the stars.

FIG. 3 shows a street system of a metropolitan area having a signal tracker system.

FIG. 4 illustrates an embodiment of a signal tracker and its components.

FIG. 5 shows an embodiment of an infrastructure component that is pluggable to a signal tracker.

FIG. 5A shows an embodiment of an infrastructure component that is integrated with the signal tracker.

FIG. 5B shows an embodiment of a pluggable signal tracker that can be plugged into an infrastructure component, while shown as 220 v, the pluggable connector can be 110 v.

FIG. 6 shows an example computing device that is arranged to perform any of the computing methods described herein.

FIG. 7 illustrates embodiments of a traffic light.

FIG. 7A illustrates a front view of an embodiment of a traffic light.

FIG. 7B illustrates a side view of an embodiment of a traffic light.

FIG. 7C illustrates a back view of an embodiment of a traffic light.

FIG. 8 illustrates a traffic light network having a signal tracker system.

FIG. 9 illustrates an embodiment of a method for controlling traffic light patterns.

FIG. 10 illustrates an embodiment of a traffic pattern control system.

FIG. 11 illustrates an embodiment of a traffic control system.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Generally, the technology relates to a traffic monitoring device that can monitor traffic to obtain traffic data and a system having a plurality of the traffic monitoring devices communicatively coupled through a network to a server computing system that can receive and analyze the traffic data. The data can be analyzed through various data analytic protocols to identify information about the individual travelers and their contribution to the traffic as well as their real time traffic action and historical traffic patterns. The system can determine traffic patterns and determine optimized traffic patterns that can be obtained by modulating the traffic pattern by modulating the operation of traffic lights.

In one embodiment, the technology includes a smart signal tracker (e.g., signal tracker) that can track traffic passing within a defined distance from the signal tracker. The signal tracker can include one or more signal detectors that can detect one or more types of signals from the traffic. The embodiment operates with traffic entities that have mobile communication devices (e.g., MCDs) that emit one or more types of signals that can be detected by the one or more signal detectors of the signal trackers. The MCDs can emit Wi-Fi, Bluetooth, and cellular signals, among other types of signals. However, the description of the technology will describe implementations that operate by detecting these three types of signals as examples, but it should be recognized that the signal tracker can be outfitted with other types of signal detectors and may detect other types of signals. The signal tracker receives traffic data from the MCDs and transmits some or all of the traffic data to a server computing system

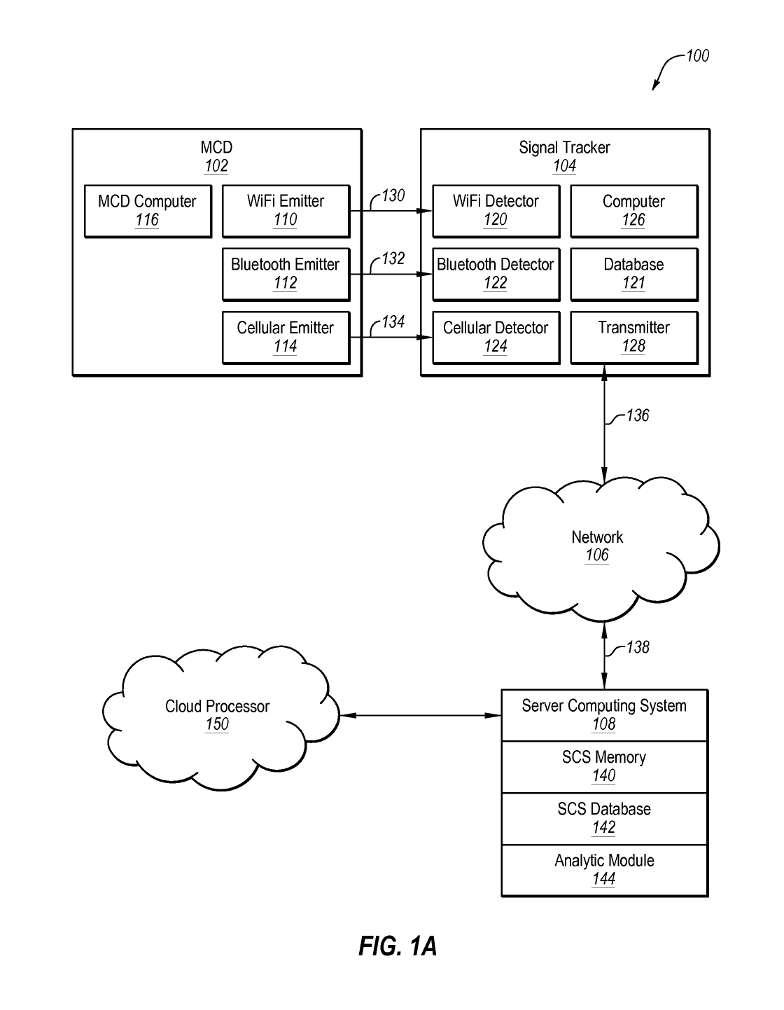

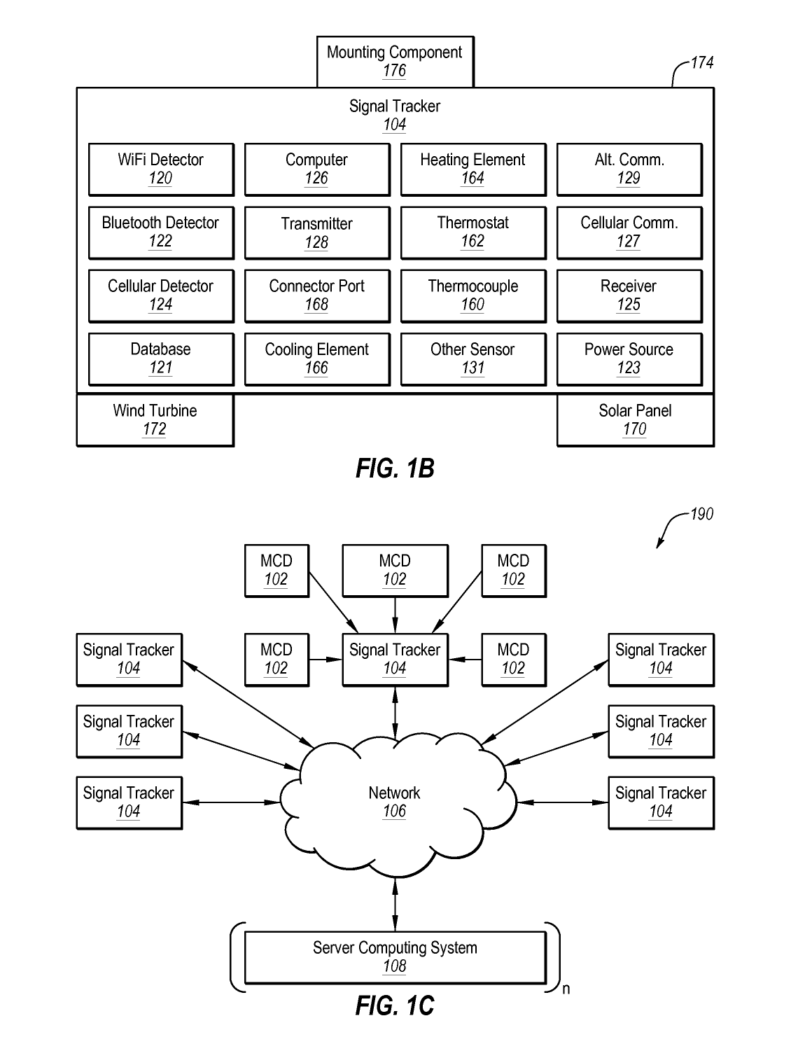

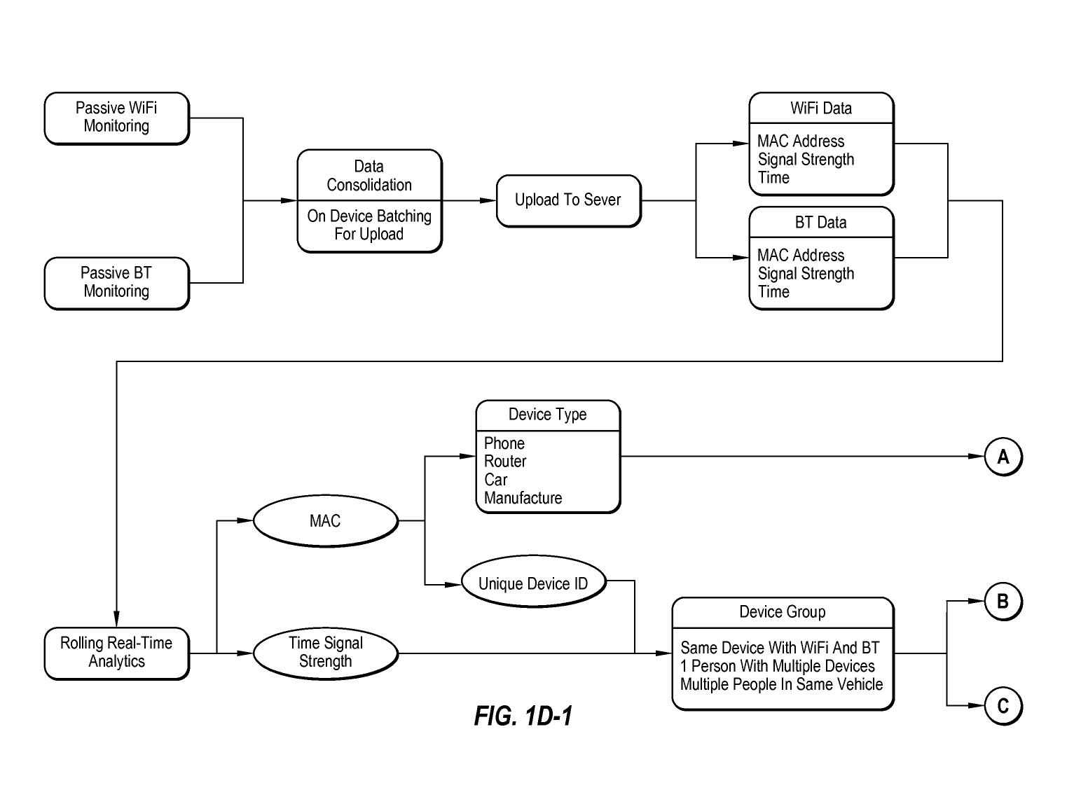

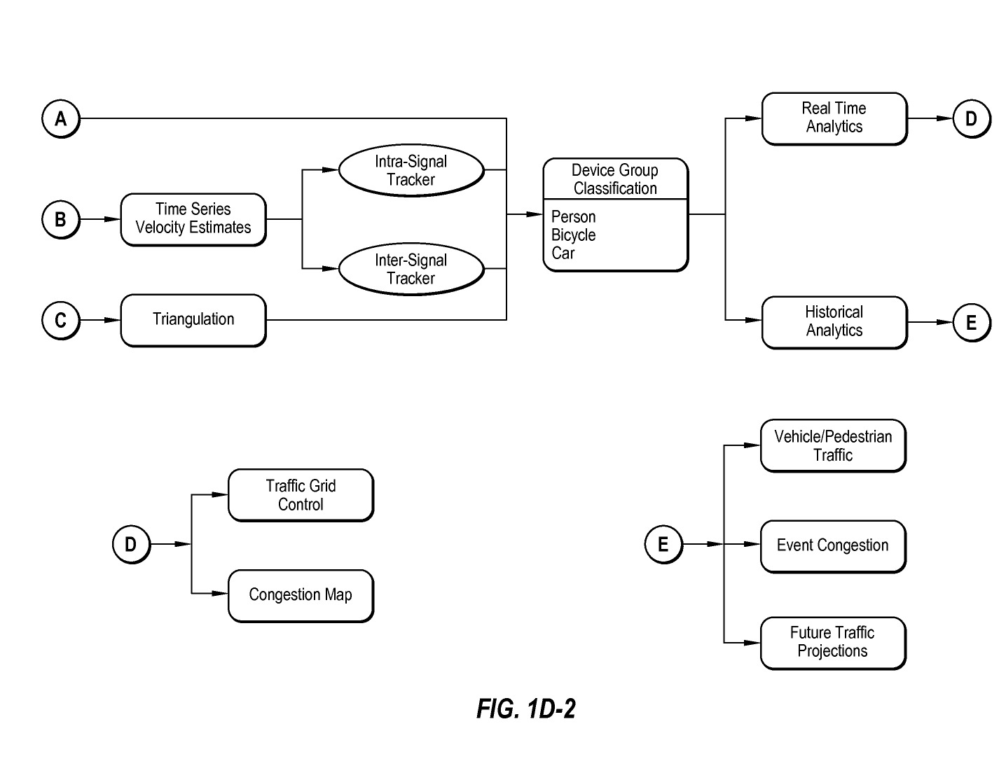

FIG. 1A shows an embodiment of a system 100 that includes an MCD 102, signal tracker 104, network 106, and server computing system 108. The MCD 102 is shown to have: a Wi-Fi emitter 110 that is configured to emit a Wi-Fi signal 130, such as when the MCD is searching for a Wi-Fi network to join; a Bluetooth emitter 112 that is configured to emit a Bluetooth signal 132, such as when the MCD is searching for a Bluetooth network; and a cellular emitter 114 that is configured to emit a cellular signal 134, such as when the MCD is searching for a cellular network. Correspondingly, the signal tracker 104 is shown to have a Wi-Fi detector 120 that is configured to detect a Wi-Fi signal 130, such as a Wi-Fi signal from an MCD that is searching for a Wi-Fi network to join; a Bluetooth detector 122 that is configured to detect a Bluetooth signal 132, such as a Bluetooth signal from an MCD that is searching for a Bluetooth network to join; and a cellular detector 124 that is configured to detect a cellular signal 134, such as a cellular signal from an MCD that is searching for a cellular network to join. The MCD can include an MCD computer 116 that provides MCD data to the Wi-Fi emitter 110, Bluetooth emitter 112, and/or cellular emitter 114, where such data is embedded in the signals (e.g., Wi-Fi signal 130, Bluetooth signal 132, and/or cellular signal 134) and the data content of such signals is well known in the art. The signal tracker 104 can include a signal tracker computer 126 that receives data for the detected Wi-Fi signal 130, Bluetooth signal 132, and/or cellular signal 134 received from the MCD 102, and performs any function with the data as described herein, which may or may not include data processing. The signal tracker 104 also includes a signal tracker transmitter 128 that can transmit a signal tracker signal 136 having signal tracker data to the network 106. The network 106 can then pass the signal tracker data to the server computing system (SCS) 108 through a network signal 138. The server computing system 108 can perform the data analytics described herein. The transmitter 128 may also be able to transmit data to the MCD 102.

In one example, the signal tracker 104 collects Wi-Fi signals 130 and/or Bluetooth signals 132 (e.g., Bluetooth being “BT”) and/or cellular signals 134, and obtains data from the collection of such signals where such data can include for example a MAC (Media Access Control) address, signal strength, time, and location, from the MCD 102. The collected data is then consolidated onboard the signal tracker 104, such as in the signal tracker computer 126, such as in a signal tracker database 121 (FIG. 1B). The signal tracker computer 126 processes the collected data to obtain relevant data and to exclude irrelevant data that is removed from the collected data. The removed data may be retained in the signal tracker database 121, or it can be purged. The data is then transmitted to the SCS 108 via the network 106, which can be a real time data transfer, or the data can be batched by the signal tracker computer 126 and uploaded to SCS 108 in a batch mode. The SCS 108 can receive the uploaded data from the signal tracker 104 and temporarily save the data in a SCS memory 140 for later insertion into the SCS database 142. The upload process (e,g., background upload process) can pick up the data in an order (e,g., sequentially, level of importance, or marked data) and insert the data into the SCS database 142. The SCS 108 includes an analytic module 144 that can analyze the data in various analytical protocols, or it can transmit the data to a cloud processor 150 for performing the analytics. The analytic module 144 can implement analytic processing of the data, and then periodically update analytics either on a processor associated with the analytic module 144 or via cloud-computing servers (e.g., cloud processor 150.

The data analysis can include the MAC address of the MCD 102 being classified into: device type based on manufacturer, model, and other specifications for later use. The traffic data including the unique MAC address, time detected by the signal tracker 104, and signal strength received from the signal tracker 104 can be used in the data analytics.

In one example, a single MCD 102 can emit multiple signals (e.g., Wi-Fi, BT, cellular, or other) that can be detected by the signal tracker 104. However, a mobile entity, such as a vehicle (e.g., car, truck, bus, bicycle, skates, skateboard, skis, etc.) can include one or more unique persons, and each person can include one or more unique MCDs 102. Accordingly, a mobile entity may have more than one MCD 102 being detected simultaneously by the signal tracker 104, and the data thereof provided to the SCS 108. The one or more MCDs 102 within the same mobile entity can be filtered, controlled for and adjusted directly on signal tracker computer 126, SCS 108, and/or cloud processor 150. The signal tracker computer 126 can generate data or receive data from the SCS 108 or cloud processor 150, and either take an action or relay information back to the SCS 108 or cloud processor 150. The signal tracker 104 can relay a data signal directly to other electronic or mechanical equipment (e.g., examples include but are not limited to traffic lights, street lights, billboards, monitors and mobile applications), and such electronic or mechanical equipment may implement an operation or change an operation in response to the data on the data signal.

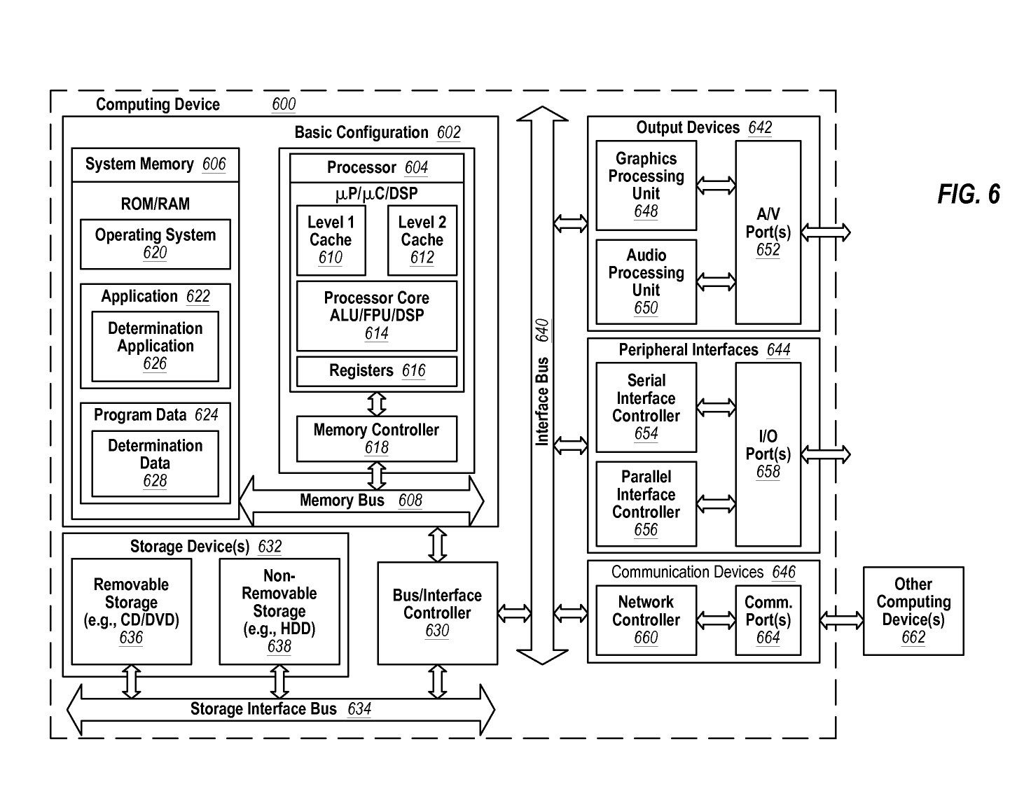

The signal tracker 104 is described in more detail herein and in reference to FIG. 1B. Generally, the signal tracker 104 can include a signal tracker computer 126, which can include aspects of any common computer, such as exemplified by FIG. 6. The signal tracker computer 126 can include a processor that operates as any computing processor. The components of the signal tracker 104 may be connected together and operate as understood by one of ordinary skill in the art. The signal tracker 104 can have a power source (e.g., battery or 110 V or 220 V or any other) 123 or receive power from an outside source. The power is provided to each component of the signal tracker 104 either by channeling power through the individual components or by using cables, wires or other means to provide the needed power to each component. For example, this can be accomplished by using a USB-hub or similar device to facilitate power transfer. In fact, any devices or methods for providing power, known or developed, may be used to power the signal tracker. The signal tracker computer 126 can include circuitry for operation of the signal tracker. The circuitry can be used for capturing: Wi-Fi MAC addresses and associated data such as signal strength and time the signal was first captured and duration of time the signal is detected, Bluetooth address (e.g., BD_ADDR) or MAC address and associated data such as signal strength and time the signal was first captured and duration of time the signal is detected, and cellular pseudonoise code (e.g., PN code) or MAC address and associated data such as signal strength and time the signal was first captured and duration of time the signal is detected. However, other signals from the Wi-Fi Bluetooth, or cellular emitter with other information may also be used. The signal tracker 104 can use the identification of the Wi-Fi, Bluetooth, and/or cellular modules, or it can group two or more of these identifiers together and/or create an identification number for the MCD based on one, two, or three of the Wi-Fi, Bluetooth, and/or cellular identifiers. This allows each unique MCD to be identified and tracked separately. The signals from the MCD 102 can act as a fingerprint that can be tracked by the signal tracker 104.

The signal tracker 104 can have a signal tracker transmitter 128 that includes the electronics, hardware, software, and antennae to transmit data, such as to the network 106. The signal tracker can have a signal tracker receiver 125 that includes the electronics, hardware, software, and antennae to receive data from the network 106. The transmitter 128 and receiver 125 can be combined into a transceiver. The signal tracker 104 can communicate with the network 106 in any possible way or combinations of ways. In one way, the communication can be via Bluetooth Low Energy. In another way, the communication can be via any communication mode, Ethernet, Wi-Fi, 3-4G or GSM or the like. The signal tracker 104 can include a Wi-Fi detector 120 that has one, two or three or more Wi-Fi antennas, which can be part of the Wi-Fi detector 120. The Wi-Fi detector 120 can gather Wi-Fi data to passively gather MAC addresses and other data (e.g., signal strength and signal detection duration and/or time) from any MCD in proximity to the signal tracker 104. The Wi-Fi detector 120 may be configured to transmit data via such as to the MCD, or to send/receive data with the SCS 108 or cloud processor 150. The signal tracker 104 or Wi-Fi detector 120 may use externally or internally mounted directional or omni-directional antennas. The Wi-Fi detector 120 may be configured as a Wi-Fi module for Wi-Fi operation and processing.

The signal tracker 104 can include a Bluetooth detector 122 that can perform a Bluetooth gathering function and a Bluetooth transmission function. The Bluetooth gathering function can use the device antenna that gathers Bluetooth MAC addresses and signal strength as well as other Bluetooth data. The Bluetooth transmission function can use a Bluetooth module or built in Bluetooth to transmit a message or short code to devices (e.g., MCDs) in its range that have identified themselves as looking to receive information from a mobile APP or partner APPs. The Bluetooth detector 122 may be compatible or not compatible with an “iSignal tracker” protocol and other similar protocol often referred to as “BLE”. The Bluetooth detector 122 may use externally or internally mounted directional or omni-directional antennas.

The signal tracker 104 can include a cellular detector 124 that can perform gathering functions and/or transmission functions as described herein. That is, the cellular detector 124 can detect a cellular signal and obtain identification information as well as other data as described herein. The signal tracker 104 may also include a cellular communicator 127 that can be implemented similar to a cellular phone to send and/or receive data, such as with the network 106, SCS 108, or cloud processor 150. The cellular communicator 127 can use cellular signals (e.g., 2G/3G/GSM or other) to send/receive data. The cellular detector 124 and/or cellular communicator 127 can use externally or internally mounted directional or omni-directional antennas.

The signal tracker 104 may also include an alternative communicator 129, which can be a transmitter, receiver, and/or transceiver so as to allow for alternative send/receive options. The alternative communicator 129 can use undefined/defined radio spectrum, such as specifically the ability to easily plug in a module that transmits and/or receives signals using any type of communication (e.g., microwave signals). The alternative communicator 129 may use externally or internally mounted directional or omni-directional antennas.

The signal tracker 104 can store data internally in the signal tracker database 121 or other memory device, which stored data is either encrypted or not encrypted. The signal tracker computer 126 can filter the data for unwanted or wanted types of data and/or signals based on the type of signal, the strength of the signal, the type of MCD, model of MCD, or time the MCD comes into or goes out of range of the signal tracker as well as the duration the MCD is within range.

The signal tracker computer 126 can include a processor capable of running embedded Linux or other operating system, and can perform calculations, process data, and execute commands for controlling all connected components of the signal tracker 104, while also being able to create a mesh network between signal trackers 104 in appropriate proximity. The signal tracker computer 126 can include on board memory that is sized appropriately, such as appropriately sized RAM, external/removable memory such as having the capability to attach a 128 GB micro-SD or SD card or other portable memory device. The signal tracker computer 126 can include a user interface or be pluggable to a user interface, which provides the ability to directly or remotely control and upgrade software via Wi-Fi, 3-4G or GSM.

The signal tracker 104 can include components for environmental management so that the signal tracker can operate at cold and hot temperatures commonly found in the environment of use. Such components can include a thermocouple 160, thermostat 162, heating element 164, and cooling element 166. The components for environmental management can use the thermocouple 160 as an on board temperature monitor and the thermostat 162 can be used for controlling the heating element 164 and/or cooling element 166 in response to the temperature provided by the thermocouple 160. The thermostat 162 may be preprogramed for temperature regulation or it may be controlled by the SCS 108 or cloud processor 150. A number of thermocouples 160 can measure temperatures inside and/or outside of the signal tracker 104. Also, external heating capabilities can be provided for by a connected solar panel 70 or wind turbine 172, which can be controlled by the thermostat 162.

The signal tracker 104 can include various external connector ports 168, which can be configured to receive any type of pluggable, such as for data communication with a separate device or a network. Examples can include Ethernet ports, I2C, USB, SPI interface, or the like, and any number of external connector ports 168 can be included. Also, the signal tracker 104 can include other sensors 131, such as those that can sense the environmental conditions around the signal tracker 104, where a weather sensor is an example.

The signal tracker 104 can be operated by any type of power source 123, such as being capable of accepting for example a +5 V signal, through a micro-USB from a 110-120V converter or a 12 V converter from either solar panels or batteries or hardwired power sources. The signal tracker 104 can monitor power usage over time by recording and reporting data on power consumption and transmitting such data to the SCS 108, such as via Wi-Fi, 3-4G or GSM.

The power source 123 may include a battery system that can be run off of harvested energy that is sufficient to run the signal tracker 104. The power source 123 may up or down convert power for compatibility with other elements of the signal tracker 104. The power source can provide power or battery management, so that it provides a minimum voltage of 5 V up to 24 V, and may be at 2 A, such as from a harvesting source (e.g. solar panel 170 or wind turbine 172, or other natural power harvesting component). The power source 123 can use or connect to rechargeable batteries (e.g. LiFo, Cadmium, etc.), which batteries can be interchangeable. The power source 123 can use a defined voltage of batteries to plug into a power board. The power source 123 can be unregulated 5V to 24 V and up to 2 A. Power can be from two sources simultaneously (e.g. wind and solar). The power source 123 can also be regulated 5 V to 24 V power up to 2 A, which may be obtained via USB or other cable and or protocol. The power source may be hard wired or plugged into a standard outlet or custom outlet.

A powered heat cable can also be included, which is a connection to a mask/material that runs behind an external solar panel to heat an element in snow/cold weather situations. A case 174 can be used to house the signal tracker 104 and components thereof, which may have an integrated or removable solar panel 170 or wind turbine 172. The solar panel 170 and/or wind turbine 172 can be attached to the case 174 so that either can be removed or can pivot, automatically or via manual adjustment, towards the sunlight or wind, and have the ability to remove if not needed. The case 174 can be configured to be able to withstand summer and winter weather conditions in harsh areas such as ski resorts or deserts, low temperatures (−20° F.), and high temperatures (125° F.). The case 174 can be shock resistant to protect from falls, such as from a height greater than 10 ft. The case 174 can include mounting components 176 so as to be easily mountable and installable in almost any environment (e.g., trees, concrete walls, poles, round or square surfaces or objects).

FIG. 1C shows an embodiment of traffic monitoring and analysis system 190 that includes a plurality of MCDs in proximity with a signal tracker 104, and a plurality of signal trackers 104 communicatively coupled through a network 106 to an SCS 108. While only one SCS 108 is shown, such SCS 108 may include multiple computers, or be at multiple locations, and generally function as a cloud processor 150. As such, there may be “n” SCS 108 in the system 190, where “n” is any integer.

FIGS. 1D1-1D2 show an embodiment of an operational protocol with the system of FIG. 1C. As can be seen, the signal tracker 104 can be utilized by passive signal monitoring of an MCD, such as Wi-Fi, BT, cellular, or other signal monitoring. The data obtained from such monitoring can be obtained by the signal tracker 104, and then consolidated and uploaded to a server, such as the SCS 108. The SCS 108 can process the data to obtain information such as MAC address or other unique MCD identifier as well as data regarding the MCD 102 entering a signal tracker zone around the signal tracker 104 where the MCD 102 can be detected, such as the time of first detection, time of last detection, duration of time residing in the signal tracker zone, as well as any other data provided by the signals emitted from the MCD 102. The SCS 108 can perform many calculations and make determinations regarding the MCD 102 being within the zone, such as rate of travel, direction of travel, road or traffic route, associated other MCDs 102 located in proximity to one MCD 102, groups of MCDs, singular MCDs in packs (e.g., traffic pack of different entities), or other information. This information can be obtained at each signal tracker 104, and the same MCD 102 can be tracked at other signal trackers 104 in the traffic system, so that a complete traffic pattern for one MCD 102, a group of MCDs, or packs of singular MCDs can be obtained for a given time period or travel period. The information can be tracked in real time and computed, and the information can be tracked over a plurality of days, and a historical traffic pattern can be obtained for the one or more MCDs. Based on historical traffic and travel patterns for a single MCD or group of MCDs or pack of individual MCDs, predictions for traffic routes and travel patterns can be predicted for these MCDs. For example, based on historical tracking over days, weeks, or months, the routine or customary traffic routes and travel patterns can be identified. For example, a person having an MCD may travel to work at a certain time or without a certain timeframe every weekday, and thereby such a common entry location and final destination for a travel route may provide an indication of where the person (e.g., MCD) is originating from and where they are going in a routine, so that the routine of the MCD can be predicted.

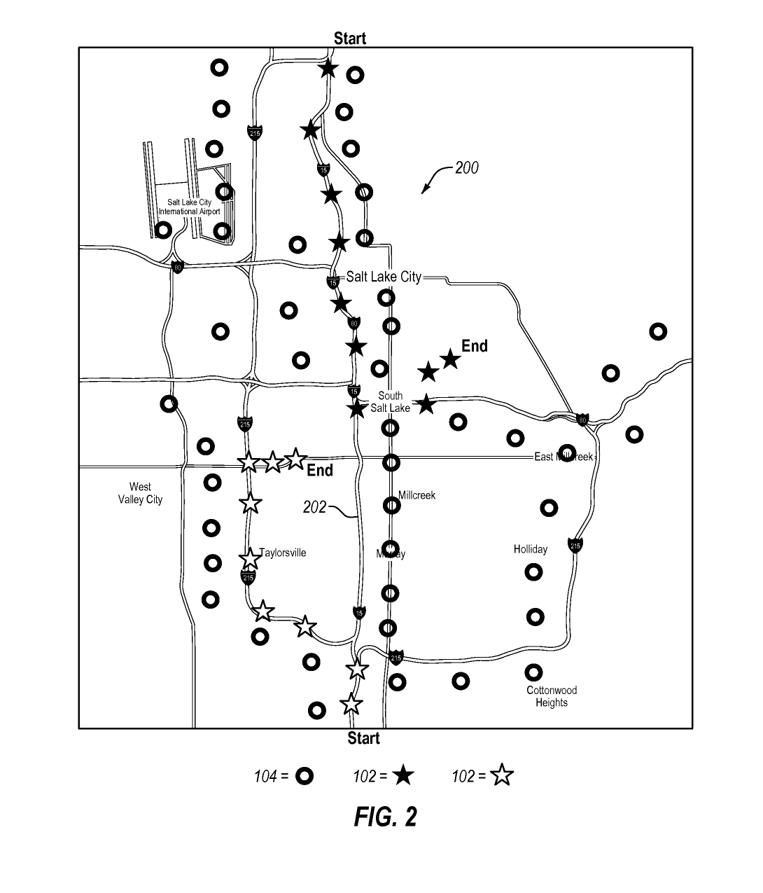

FIG. 2 shows a map having a schematic representation of a plurality of signal trackers 104 of a signal tracker system being deployed along a metro surface street system of a geographical area, where the signal trackers 104 are distributed in a manner to track MCDs, which are shown by the stars. Note that two different MCDs are shown for illustrative purposes. The signal tracker zones may overlap, or there may be gaps between signal tracker zones. As such, only one or a plurality of signal trackers 104 can detect a single MCD at a specific time point. The signal trackers 104 can be at any location associated with the street system, and may include signal trackers 104 at road entrances and exits, intersections, junctions, or any location therebetween. As shown, the black star MCD enters the signal tracker system (e.g., Start) and travels south on a road, makes turns at a few intersections before arriving at a destination (e.g., End). The white star MCD enters the signal tracker system (e.g., Start) and travels north, makes turns at a few intersections before arriving at the destination (e.g., End). As such, the system can track each MCD separately along their travel route. This allows tracking a single MCD, and thereby the person having the MCD can be tracked. This allows for tracking where the MCD is going and overtime it allows for determining habits or routines or places the person owning the MCD goes.

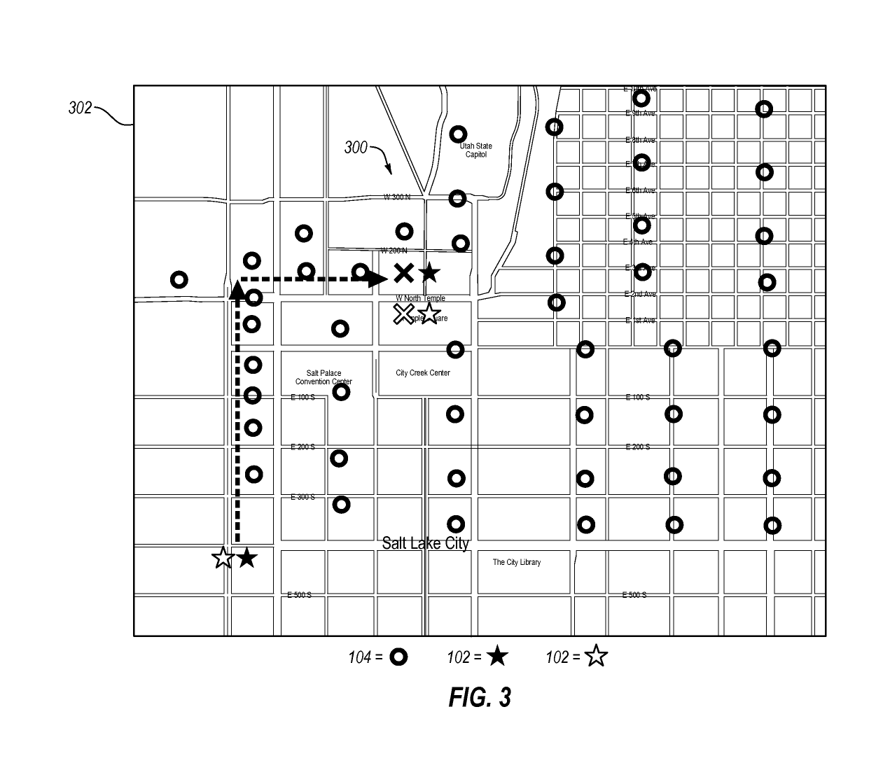

FIG. 3 shows a street system 302 of a metropolitan area having a signal tracker system 300; however, it should be recognized that any geographical area can have a signal tracker system. Here, only the signal trackers 104, shown as black donuts, along the travel path of the MCD 102, shown by the dashed area, are shown. However, the signal trackers 104 can be anywhere in any distribution, in any concentration, and in any degree of having signal tracker zones overlap or be distinct and separated by gaps. The black star MCD and white star MCD appear to be traveling together, such as in a common vehicle. Here, the final destination for the black star MCD is shown by a black “X” that marks the spot where the black star MCD ceases to travel; however, the final destination for the white star MCD is shown by the white “X”, which is a different final location compared to the black star MCD. This indicates that these two separate MCDs are for two different people that rideshare or otherwise traveled together to a parking spot, and then each MCD goes on to their own final destination, such as different work locations. This example shows the ability to track MCDs that in some periods move in a common travel route and then separate to their own final locations, and each can be tracked separately. Over a historical context of days or weeks or months, if this travel pattern occurs frequently in a similar timeframe each day, then these people may travel together such as in a carpool, and then separate to travel to their individual job locations. On the other hand, if the tracking only occurs once in a historical period, then it may be a one-off travel route. Data processing can make such determinations, where both can be useful for different contexts, as described herein. The signal trackers 104 can be at intersections, on traffic poles, in traffic lights, on cables between poles, on power poles, on street signs, on trees, on buildings, and at any location therebetween. The signal trackers can be in plain sight or camouflaged and/or hidden. While only one MCD travel route is shown, the signal tracker system can track any number of MCDs.

The location data of an MCD at any given instant can be presented on any coordinate system, such as a map coordinate, street coordinate (e.g., address), or GPS coordinate, or the like.

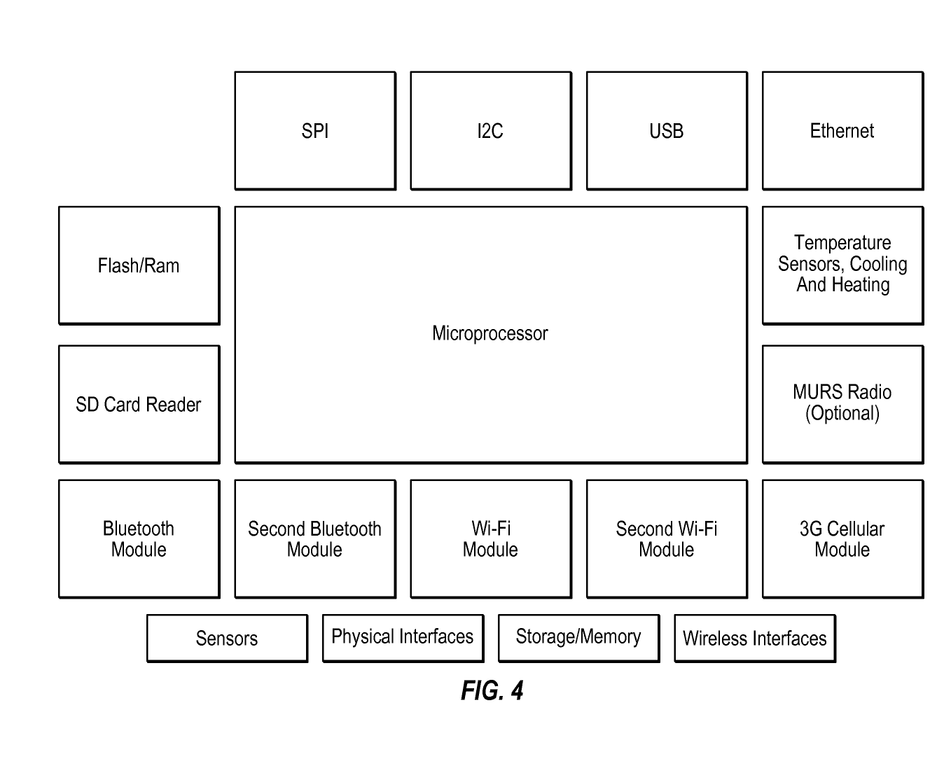

FIG. 4 illustrates an embodiment of a signal tracker 104 and its components.

In one embodiment, the data analysis of the travel data from one or more MCDs can be used to determine road conditions. The road conditions may be estimated by the number of travelers on a given road portion. The road conditions may also be entered into an application and provided to the system. The travel data can be used to determine the number of miles or vehicles driven on a road, and can estimate a road usage for a given portion of a road. The estimated road usage can be used to estimate the road condition. The travel data can be used to predict the condition of the road based on the usage over a given period of time. The travel data can be used to predict maintenance issues, such as pot holes, weathering, ruts, divots, or other poor road conditions that may need maintenance. The travel data can also be used to predict when the road will need to be resurfaced or other maintenance. The system can provide alerts to the travelers as well as an entity responsible for maintaining the roads, such as a city or department of transportation. The system can provide alerts regarding roads conditions, maintenance issues, construction, mileage driven on road, number of uses for a given period of time, predict total traffic. The alerts may be texted to MCDs or sent via email or via an application on the MCD. The traveler may register the MCD with a service to receive such alerts.

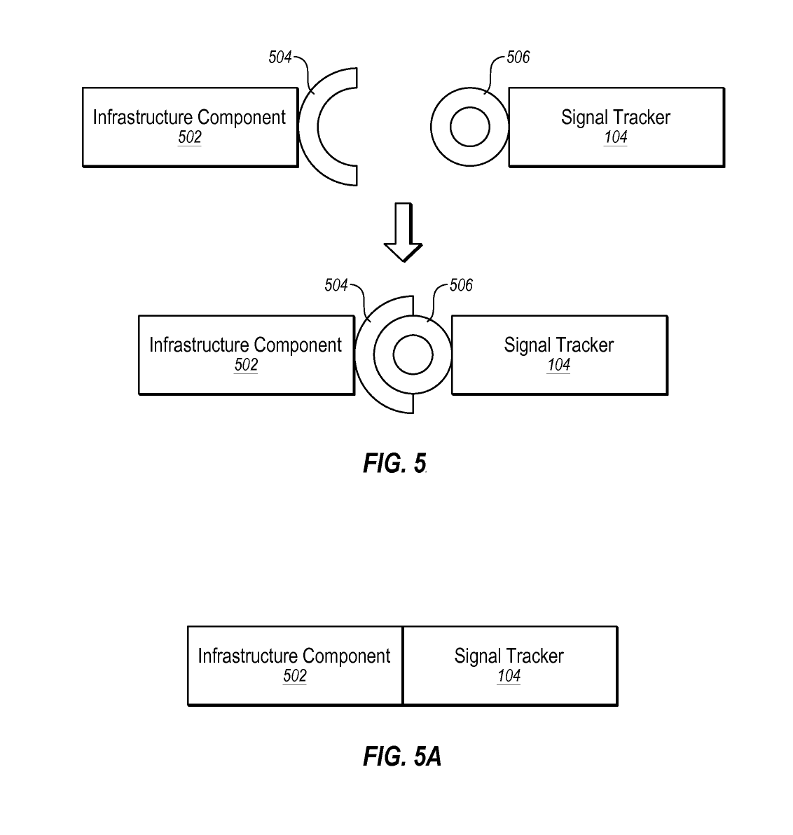

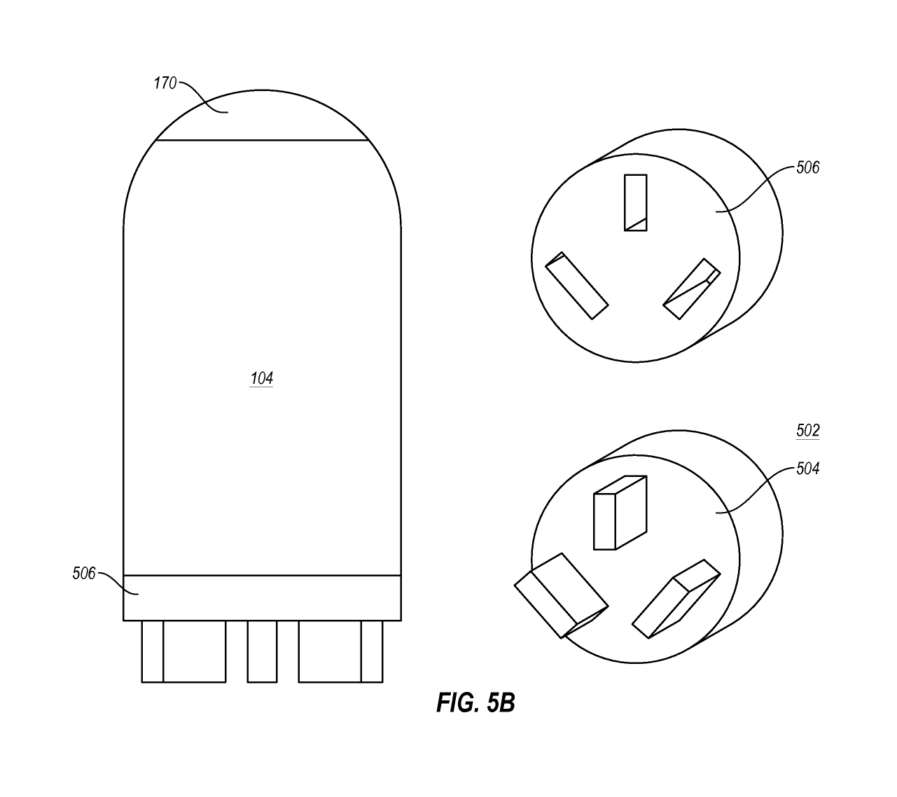

FIG. 5 shows a component of a municipality infrastructure (i.e., infrastructure component 502) being operably coupled with a signal tracker 104. As shown, the infrastructure component 502 has a coupling mechanism 504, and the signal tracker 104 has a coupling mechanism 506, which coupling mechanisms 504, 506 can be plugged into each other to operationally couple the signal tracker 104 to the infrastructure component 502. This can allow the signal tracker 104 to draw power from the infrastructure component 502 for operation of the signal tracker 104. The infrastructure component 502 can have an existing coupling mechanism 504 or the coupling mechanism 504 can be added to the infrastructure component 502 for the purpose of coupling with the coupling mechanism 506 of the signal tracker 104. In some instances, the infrastructure component 502 can have a power outlet that is used as the coupling mechanism 504, or a power outlet can be coupled to the power of the infrastructure component 502. The infrastructure component 502 can be a street light, traffic light, cross-walk signal, power box, transformer, or other component that has power.

FIG. 5A shows an infrastructure component 502 integrated with a signal tracker 104. That is, the infrastructure component 502 is manufactured to include a signal tracker 104 therein. This can allow for municipalities to upgrade infrastructure components 502 with those having integrated signal trackers 104. Such manufacturing can use any means to physically and/or electronically integrate a component 502 and signal tracker 104.

FIG. 5B shows an example of an infrastructure component 502 that can be pluggable with the signal tracker 104, where the coupling mechanism 504 is shown as a 220 V male connector that couples with a 220 V female connector of the coupling mechanism 506 of the signal tracker 104. The signal tracker 104 is also shown to have a photovoltaic component (e.g., solar panel 170) that can be used for powering the signal tracker. While one example of the coupling mechanisms 504, 506 is shown, any other can be used.

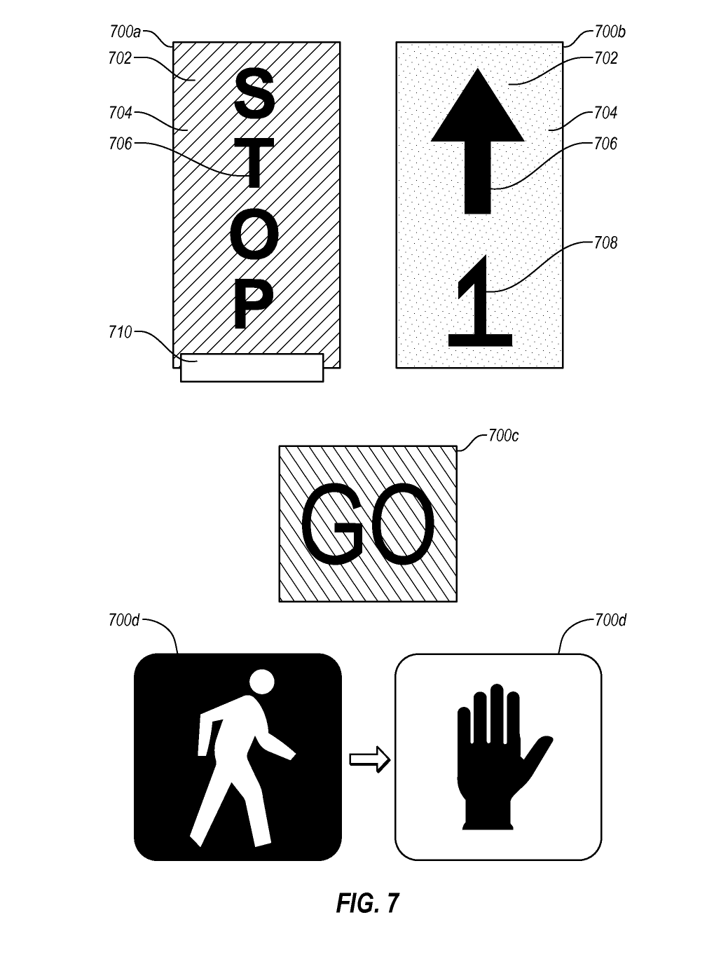

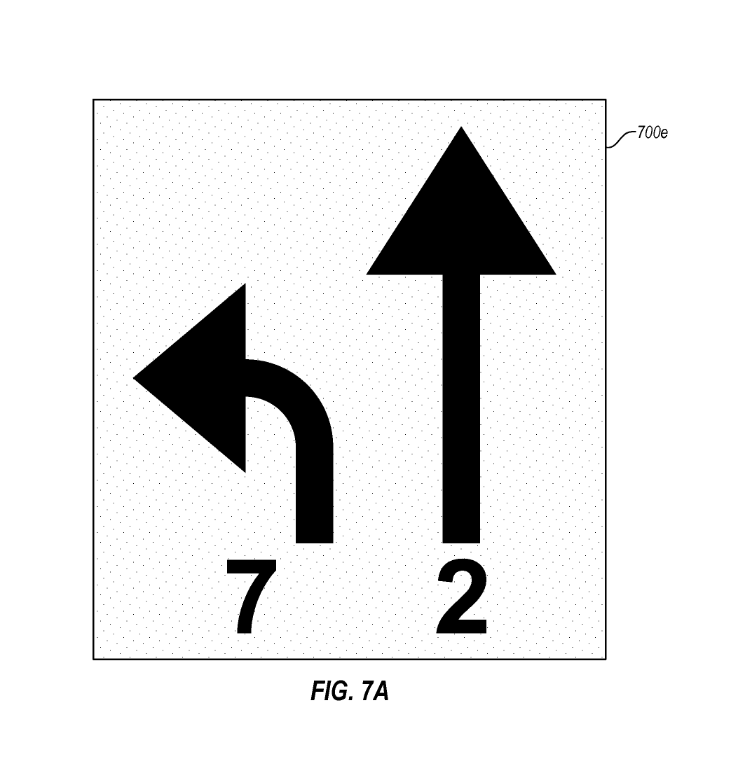

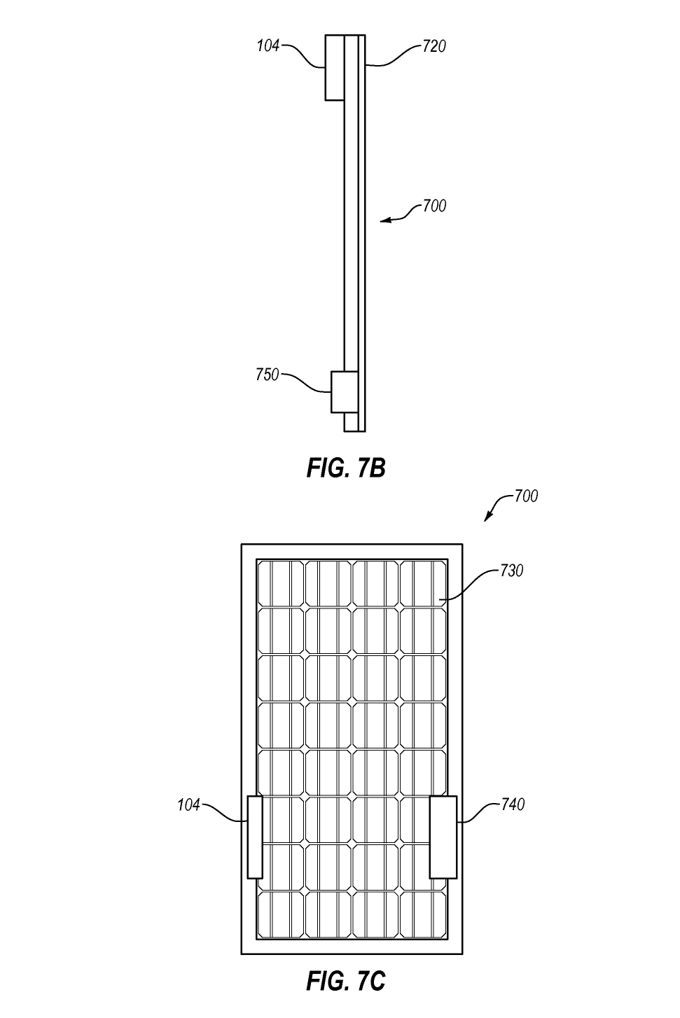

FIG. 7 shows an example of an infrastructure component that may optionally be integrated with a signal tracker 104. The infrastructure component is a traffic light 700a-c. The traffic light 700a-c is shown to include a display 702 that can have the background 704 and/or foreground 706 illuminated. The display 702 can be used to show anything and in any color that can be presented on a display, such as a computer display or television screen. This is possible because the display 702 can be configured as a screen, such as a computer screen, device screen, MCD screen, or the like. The display 702 can be LCD, LED, OLED, or AMOLED, or other, and thereby can display substantially any image or information or video. The traffic light 700a-c may also be configured as a computer, such as having the elements of FIG. 6. The traffic light 700a-c may even have speakers 710, so that video with sound can be played by the traffic light 700a-c. This can allow for the traffic light 700a-c to provide image traffic information in the form of images, sound, video, and audio/video. This can allow for improved audible commands that provide verbal commands as well as tone or beep commands. However, for a benefit to the visually impaired, the verbal commands can provide easily-understood information in words, phrases, and sentences. Here the traffic light 700a is shown as a “STOP” light that has the background red with the letters being white; however, the colors may be changed. This image may be accompanied by an audible “STOP” emitted from the speaker 710. The traffic light 700b is shown as a direction light that has an arrow that is a dark color and the background a lighter color, and also shows a countdown 708 that counts down the time until the display 702 will change, where the number 1 indicates the display 702 will change in 1 second. This may be accompanied by audio instructions or an audio countdown. Additionally, the traffic light 700c can show the word “GO” illuminated with the color green. Also, the traffic light 700c can show any word or combination of words in any language or combination of languages or symbols or combinations of symbols or pictures or combinations of pictures, or any combinations thereof. In fact, anything that can be shown on a display can be presented by the traffic light 700c. Also shown is a crosswalk light 700d where the display can change from a symbol that indicates it is safe to walk (e.g., white human figure) to a symbol that indicates it is not safe to walk (e.g., orange hand). However, the crosswalk like 700d may also display words such as “WALK” or “DON'T WALK” to provide the message to a person. Accordingly, the traffic light or crosswalk light, or any other traffic-related light can be configured with a display to illustrate any symbol, sign, or message, where these lights can be controlled and updated as desired, and may be operated similar to a computer display screen, which can be programmable and changed in real time. As such, these traffic-related lights can be computer devices with the display.

FIG. 7A shows another type of traffic light 700e that has a size sufficient for use in providing traffic instructions to multiple travel lanes. The traffic light 700e is extra wide, and shown to have information for two lanes; however, the traffic light 700e may be wide enough for information for any number of lanes going in a common direction and even left and/or right turn lanes, where the example shows a turn lane and a through lane, with countdowns. The size of the traffic light 700e can vary, and can be as large as a jumbo screen at a sports arena. Custom sizes can be created to be adapted to be retrofitted into existing roadway architecture.

FIG. 7B shows the side view of the traffic light 700. FIG. 7C shows the rear (back) view of the traffic lights 700. The use of the display allows for a thin low profile side, and which can use a sun shield 720 to shade the display. The sun shield 720 can extend from the body of the traffic light 700 to protrude above and/or around the display. The rear of the traffic light 700 can be any configuration, and may include an integrated photovoltaic device 730 for solar power, or it may house a battery 740. The devices may also be configured to function with the battery 740 when the power is off, or emergency flash during a power outage. Similar with other traffic lights, a connector 750 for mechanical (e.g., mechanical connector) and/or electrical (e.g., electrical connector) connection can be included, which may be for power and/or information uploading/downloading.

While the traffic lights 700 are shown with only one display 702, the traffic lights 700 can include a display 702 on each surface. This can include the traffic light 700 having four displays 702, so that the traffic light 700 can control an entire intersection. While four sides may be common, the traffic light 700 can include 1, 2, 3, 4, 5, 6, or more displays 702. Modifying the width can allow for a single traffic light 700 to control all the lanes in four different directions.

These traffic lights 700 may also be configured with the components described herein for a signal tracker 104. That is, these traffic lights 700 can have internal signal trackers 104 that operate as described herein. The traffic lights 700 may also have the thermostat, thermocouple, heater, and or cooler for heating and cooling to an optimal operational temperature range. The traffic lights can have embedded signal trackers, sensors, counters, temperature modules, batteries, and humidity sensors. Some exemplary components and configurations can include: Embedded Blyncs technology (signal tracker), sensor, traffic counter, etc.; LCD, LED, OLED, AMOLED or other display (weather conditioned or insulated); temperature control, such as with a thermometer, and other weather sensors (humidity, etc.), the display itself can use the primary traffic colors (e.g., green, yellow, red), but it can use others, the display can darken arrows or words indicating direction, while the majority of the panel turns green, yellow, red, etc., or vice versa, which can make it easier for color blind or impaired individuals to know when the traffic light changes and how the traffic should respond to the traffic light; at the bottom of the display, or anywhere, there can be numbers that count down, indicating how long until the traffic light changes next, a wider traffic light can have turn arrows or words and service multiple traffic lanes, including turn lanes and through lanes; the display can show unique shapes, and traffic symbols that can be displayed, such as flashing “STOP” for power outages, etc., there can be a sun visor surrounding the light, or at least around the top and sides; the traffic lights are much slimmer and lighter than existing lights; and an optional embedded solar panel with/or without a battery to allow for power outage flashing lights.

The signal tracker system can obtain information for the traffic monitoring system to make determinations of the travel routes and patterns of moving people into the city or into a metro area as well as moving within such areas. The data can be meshed with map data and location data so that the places the MCDs visit can be determined and analyzed. The data can be meshed with weather data, location or other data so that the places the MCDs visit can be determined and analyzed. The data can be meshed with traffic data and location data so that the places the MCDs visit can be determined and analyzed. Also, any of these types of data can be meshed for the determinations and analyses. This allows for determinations of what the MCD is doing, how the MCDs move to certain places, because the system is monitoring their location and traffic pattern, whether in a vehicle and/or pedestrian.

The system is configured to track an MCD, such as a phone, a tablet, a connected car, or any other MCD that can be tracked as described herein. This allows the system to process data to identify one or more MCDs associated with a common person, and to associate a person with a group of people with a similar travel pattern, or common destination. The travel information for a particular MCD or group of MCDS can be obtained at any rate of travel, and the rate of travel can indicate travel by car, bicycle, or pedestrian travel. The data can be processed and provided to an entity for traffic management.

In one embodiment, MCD traffic volume can be determined so that the number of MCDs passing a certain traffic light can be used to calculate traffic volume in a given timeframe. For example, the historical and real time MCD traffic density for location can be determined traffic patterns can be associated with the historical MCD traffic density or real time MCD traffic density.

In one embodiment, the traffic system includes an application (e.g., App 111) installed and operating on the MCD. This application can be used to obtain information as well as provide traffic information to the user of the MCD. The information can be traffic information about traffic volume, traffic speeds, estimated travel times, traffic congestion, congested streets, uncongested streets, alternate routes, faster routes, or other information, which can be displayed on the screen of the MCD via the application. The application can provide maps that show the location of the signal trackers, or the signal trackers can be hidden. The map may show the location of MCDs being tracked or show areas of congestion or light concentration of MCDs. The application can push the traffic information to the MCD when the MCD is in a certain location and/or at a certain time based on real time traffic data and historical traffic data. The application can push traffic information to one or more selected MCDs based on the real time or historical travel routes and travel patterns. The map can also show historical traffic patterns and traffic density for locations, where the map can be interacted with to select showing certain times of day or certain days of the week. This can allow the user to look up historical and estimated traffic for a particular route or location for any given time on any given day, such as weekdays and weekends. For example, a person may be interested in the traffic history for a route from a first location to a second location for rush hour on Mondays, and such information can be selected and presented to the person on the map. This may be helpful in determining travel routes as well as in decisions of where to live or work.

In one embodiment, the signal tracker or the SCS can process the data to remove identifying data. In some instances, there may be laws, rules, or regulations regarding the type of information the SCS can process or retain, and any other information can be tagged and discarded. The signal tracker system can be configured to only collect anonymous data relevant to the unique identifiers of each MCD, but personal information about the user or other may be discarded at the signal tracker or at the SCS.

In one embodiment, the signal tracker system may or may not have signal tracker zone overlap. In any event, the signal tracker system can employ triangulation or trilateration to pinpoint the location of the MCD, and thereby the person. Such triangulation or trilateration can be performed at the signal tracker or at the SCS. The signal trackers can record the travel speed, direction, change of direction or other information at a given signal tracker as well as the signal tracker system tracking an MCD across multiple signal trackers to calculate the travel speed and route.

In one embodiment, a unique MCD can be tracked everywhere it goes in a signal tracker system or across multiple signal tracker systems (e.g., a signal tracker system for each city, and travel through multiple cities, or even states). The MCD can be tracked daily to determine routines or common travel routes and travel patterns. Over time, the system can predict when and where the MCD will go based on the historical data. The same processing can be done with groups of MCDs with common originations, common travel routes, common destinations, or any other commonality. The same processing can be done to parse out MCDs from a common vehicle, which may be used to establish predicted relationships between the MCDs. For example, two MCDs may not have common traffic routes or patterns, but they may arrive at a common destination in the same timeframe on repeated occasions, where the common destination may be constantly changing or staying the same, and thereby the system may determine that MCDs are owned by people that are acquaintances or share common interests. Over time such information can be used for mapping social connections of people having the MCDs.

In one embodiment, the system can partition MCDs into groups with similar behaviors. The groups can be employees, visitors, tourists, residents, or any other similarity. The groups can also be the MCDs that are determined to travel in a particular route at a similar time during the same days of the week, such as the rush hour commute. For example, if a certain MCD has not been detected in a signal tracker system for a geographical location (e.g., city), the MCD may be owned by a tourist. This can allow for filtering this MCD from those that are determined to belong to different groups. Some groups can be more relevant to some businesses compared to other groups or other businesses.

In one example, a municipality may be interested in the different types of people (e.g., people groups) that go to Main Street for traffic management purposes. So, initially they're interested in when people are coming to Main Street, where they are on Main Street, and how long they stay on Main Street, and when they leave Main Street. The system can track the people via the MCDs and make various determinations and estimates for these people and what they are likely to do on Main Street. Once a traffic pattern can be determined, the timing of traffic lights can be modulated at certain locations (e.g., main roads) at certain times, and then the traffic pattern post traffic light modulation can be analyzed to see if there was a change in the traffic pattern based on the traffic light modulation. Such analytics can be used to provide for improved traffic flow to allow a higher traffic volume to pass through intersections to destination locations, and determine when certain traffic light settings is more effective to change a traffic pattern routine for one MCD or a group of MCDs. Such modulation can improve traffic flow through intersections to reduce bottlenecks.

The municipality may be interested in the impact of events, such as how summer concerts impact traffic on Main Street. The system can track and analyze the data to provide such information and to provide suggested changes to the traffic light patterns to improve traffic flow to and from an event. The municipality can implement a change to the traffic light pattern between events and then a determination can be made as to how the change modulated the traffic pattern to improve the traffic flow. This allows for putting changes into perspective as to the effect on traffic light pattern, and then additional change iterations can be made until the municipality obtains a desired traffic pattern for any timeframe or event.

In one example, a location may have a certain traffic pattern before a traffic light pattern is modulated, and then a different traffic pattern after the traffic light pattern is modulated. The system can record and analyze the traffic patterns for a determination of the travel time impact to the area, which may be a positive travel time impact for some travel times or travel routes or a negative impact for other travel times or travel routes. Such information can assist in determining which types of traffic light patterns can be implemented at different times of the day, week, or relative to events. The same type of analysis can be performed with any changes, such as new stores or developments that may change the traffic pattern in the general area or to main roads to such new stores or developments. This can be used to allow for analyzing traffic patterns based on events or changes in destinations that change traffic patterns, and then to devise a new traffic light pattern to improve the traffic flow through the traffic lights.

The system may also be implemented with mass transit systems (e.g., trains, buses, or the like and combinations thereof) to see the effectiveness of certain programs. This can allow for the mass transit system to have schedules adjusted based on the traffic patterns, and then reassessed to see if there was an improvement in the traffic pattern after the schedule adjustment. The systems can be used to improve traffic flow. The signal trackers can be in static locations, such as terminals and stops, or on moving vehicles like trains or buses. The signal trackers can have a GPS module for static or dynamic tracking of the signal tracker.

In one embodiment, the signal tracker system can receive signals from devices other than MCDs, such as static devices like personal computers. The system can detect any device that emits a detectable signal, and based on the historical detection of such a signal, the system can determine if the signal is from an MCD that can move around or if it is from a static device, such as a personal computer. The system can detect a large number of MCDs and other devices every second and filter out the devices so that only relevant MCDs are recorded and processed by the SCS. The signal tracker can purge the date from the database once the data is uploaded to the SCS. This allows for rapid detection of unique MCDs. Additionally, if the types of MCDs change or the types of signals emitted from the MCDs change, the signal trackers can be updated or newly configured with signal detectors to detect the new types of signals.

In one embodiment, the system can be used to distinguish different people from each other even if they travel together or have the same travel route or travel pattern. The person may have one or more MCDs, which they often carry together. This allows the system to track these MCDs and verify the same travel route or travel pattern over a defined historical period, and thereby these MCDs are linked to a common owner. As such, each time one of these MCDs is detected, only one is tracked for traffic purposes because they are all indications of the same person. Similarly, multiple people can travel together for the same travel route or travel pattern, such as on a bus, train, or carpooling. However, in most instances there will be some divergence in the travel so that the MCDs separate and go in different directions, where this allows for determining unique MCDs for unique people. The statistical association of MCDs and statistical dissociation of MCDs can be used to identify a unique person with one or more MCDs from other unique persons. This allows for the data processing to provide a more accurate assessment of traffic based on unique people (e.g., possibly having multiple MCDs) instead of unique MCDs. Such data processing can be useful for traffic light pattern management because the MCDs can be grouped to a person or to a vehicle so that a vehicle is only counted once on a travel route, which more accurately indicates the vehicle traffic volume.

The traffic being detected and analyzed can be any traffic, such as mass transit traffic, vehicle traffic, bicycle traffic or foot traffic. Each can be analyzed separately based on conglomeration of MCDs, and rate of travel, where different modes of travel often have different speeds and/or different numbers of MCDs traveling together. Buses hold more people than cars, cars travel faster than bicycles, and bicycles travel faster than pedestrians. However, for traffic management, the traffic is motor vehicle traffic or traffic on a road. Such motor vehicle traffic can be analyzed by processing and determining the number of MCDs associated in a common vehicle, whether a car, van, or bus, so that each vehicle is only counted one time for traffic light management.

The system described herein can be used to detect and track anonymous identifiers in order to analyze human traffic patterns to provide information improved traffic light management.

The system uses the MCDs to provide information to the signal trackers that connect with any network in any way of communication to a central area where the system has one or more central computing areas for analytics. The central areas perform some analytics on the data obtained by the signal trackers from the MCDs, and then provide meaningful analyses on the traffic pattern and what the traffic pattern means. The signal trackers can pick up the information, do some filtering, do some processing, and then pass data onto the server, and the server gets that information and does the bulk analysis by running algorithms.

The signal trackers can also be controlled by the SCS, or by a user that interfaces with the signal trackers. The signal trackers include the signal tracker computer, which allows for updating (e.g., remote updating or on-site updating or physical updating, etc.), and providing operational instructions. For example, the signal trackers may be only concerned with vehicle traffic, and thereby can be programmed to filter out and exclude date from MCDs with low velocities, such as bicycles or pedestrians that do not impact vehicle traffic volume. Also, the signal tracker can be configured to ignore any static devices that do not move but that sends out signals that can be detected by the signal trackers, which can be useful to filter out static devices in an office building close to a street intersection having traffic lights.

In one embodiment, the signal trackers can include a tracking device. This can be helpful in theft deterrence or signal tracker reclamation after being stolen. For example, if the signal tracker is moved, it may provide real time information about its location, such as by providing the GPS data or emitting a signal that indicates it has been stolen or moved. The signal tracker might turn on, validate itself, and check whether it has been stolen. If the signal tracker is in the correct location then it is not stolen. If the signal tracker asks for a validation code, the server can send the code and the signal tracker can determine if it is in the proper location. If the signal tracker were to power off or be indicated as being stolen, all of the data that was stored, even proprietary code for operation of the signal tracker, in volatile memory can be erased. The signal tracker may also include a self-destruct mechanism to destroy operability upon a command received from the SCS or authorized entity, or if it determines it is not in the proper location or has been stolen. The new GPS coordinate for a miss-located (misplaced) signal tracker may also be uploaded to the SCS so that the signal tracker can be found.

The analytics are in real time or on historical data. There is a class of analytics that are important for real time, such as major events like concerts or sports games with a large number of people in a certain location that are about to leave in vehicles and impact the traffic volume for a given area. This may be helpful for a municipality to manage the traffic lights in real time. Also, there is a class of analytics when the data processing is more focused on traffic from an event, and locations where the traffic gets congested at a traffic light, and where there may need to be proactive operations to alter the operation of the traffic light to improve the traffic flow, which can be in real time or based on historical traffic patterns for similar events. The system is concerned with analyzing the data and providing information regarding traffic volume at the traffic light, and optionally the system has precomputed a traffic light pattern based on historical data and on historical trends in order to handle higher traffic volumes. This allows the system in real time to perform analytics to identify an event is occurring, and then trigger a precomputed sequence of operational parameters for the traffic light to improve traffic flow. This allows the use of historical analytics to impact traffic in real time in order to change the traffic flow in real time or to make notifications in relation to certain events.

For example, the system can push information to a municipality entity, such as notifying a traffic light manager, when the real time data based on a historical trend indicates they will get a large influx of vehicle traffic at a certain traffic light or group of traffic lights. This can assist the entity to reconfigure traffic light operations or obtain assistance to handle the influx of vehicle traffic so that certain intersections with traffic lights are not overwhelmed and cause traffic congestion. This type of data analysis can be based on a real time occurrence that maps and matches some historical event that has been analyzed before. The system can provide real-time alerts to the entity. This allows real time traffic light operational adjustments based on real time data analyzed in view of historical data. Such analytics may not be based on a unique MCD, but on a certain number of unique MCDs that are in a common location or common traffic pattern.

In one embodiment, the signal trackers and SCSs can have software technology for implementing the protocols described herein. The software can be an API. Also, the signal trackers can be integrated with other devices that are commonly found in traffic areas, such as traffic lights, street lights, power stations, power boxes, or other. For example, a traffic light or street light can be manufactured to include an on-board signal tracker, and thereby the signal trackers can be deployed when the traffic light or street light is installed. In non-limiting examples, the signal trackers can be integrated and embedded: in traffic lights, whether custom traffic lights, or those of other manufacturers; street light that can have an OEM model where existing lighting manufacturers embed the signal trackers or unique street lights can be manufactured with the signal trackers. Also, the signal trackers can be a 120 v “standard” or 220 v “dryer outlet” style device that is about the size of a water bottle. This can allow for the removal of a photovoltaic sensor on a street light and replace it with a signal tracker unit that also has the same function. Accordingly, this can allow for remote control and timing of the street light, such as turning them all on or off, making them all flash, or any other function. In some instances, a signal tracker can be integrated with a streetlight, which sends data to the SCS for analysis, and then the SCS sends information to alter the traffic light pattern of a traffic light near the streetlight signal tracker. The signal tracker can also send data to the MCDs.

As described herein, the data that is collected from the system can be analyzed to determine various traffic pattern metrics. The information obtained from the analytics can be used for various purposes, such as to improve traffic flow, determine the type of travelers in traffic, determine the origination area of travelers for certain travel time periods, determine the destination area of travelers for certain travel time periods, determine destination habits for travelers, or the like.

In one embodiment, the signal trackers can be used to track a specific MCD, and then to alter the traffic light pattern for the travel route of the MCD. In some instance, the traffic light patterns can be modulated on the travel route so that the MCD has a faster rate of travel through the route. For example, a very important person (VIP) having an MCD (e.g., MCD known to municipality) may be traveling through a city, and the city may want the VIP to arrive at a destination without stopping at a traffic light, and thereby the signal trackers can track the VIP and provide data so that the traffic light patterns can be modulated to allow the VIP to travel through a route without stopping at a traffic light. This may also be done for a group of MCDs. In some instances, the traffic light patterns can be modulated on the travel route so that the MCD has a slow or stopped travel through the route. For example, a suspected criminal having an MCD (e.g., the MCD identification information made available to law enforcement personnel for tracking purposes) may be trying to evade police officers, and the municipality can slow the travel or even stop travel on the escape route by modulating the traffic light pattern to allow the police officers to converge on the location of the MCD, which location is provided by the signal trackers.

In one embodiment, the data can be used for analytics regarding travel time calculations. That is, the real time and historical data can be used to determine real time travel time from an origination point to a destination point for a traveler for the mode of transportation for the traveler. This can include travel time duration of travel estimates for bus, train, car, motorcycle, or other modes of transportation. The data from a first signal tracker can be processed to determine the rate of travel proximal the first signal tracker, which allows for an estimation of the current mode of transportation, which can be compared to other modes of transportation for the MCD of the traveler as well as other rates of travel from other signal trackers in the travel route that have identified the MCD of the traveler. The route of travel can then be used to estimate the next signal tracker that will detect the MCD of the traveler. The information can determine the time it takes to get from location A (e.g., near one signal tracker) to location B (e.g., near another signal tracker). The data for one MCD can be compared to data for other MCDs that may have similar travel data. The processing can separate out MCD data for MCDs in cars, bikes, or walking by speed, route, or the like, and the similar modes of transportation can be grouped into various different groups related to that mode of transportation, and the different modes of transportation can be separated into different transportation mode groups. The data can be processed to determine the average and mean travel times between two locations, and can find commonly taken routes between these locations with a predicted travel time between the two locations. The predicted travel times as well as the average travel times can be based on certain travel periods, which can be, for example, during morning rush hour on a select day of the week, or the like. Each travel period can be determined by time increments for select periods for each day. For example, traffic at a first route on Monday at 8 AM may be different from traffic on that first route on Monday at 7:45 AM and 8:15 AM, and thereby each travel period for each day can be mapped and analyzed separately. Such information can be used for predictive traveling. The information for this type of data processing can be used to change the predicted travel time between two points by modulating the traffic light pattern therebetween.

The data processing can be performed to determine MCD associations with a common person and MCD dissociations between different people that may travel at least part of a travel route together. That is, by analyzing real time and historical travel data, a person can be defined to have multiple MCDs. Also, by analyzing real time and historical travel data, people that travel at least part of a travel route can b e distinguished between each other, such as for example by mapping divergences. This can be useful for distinguishing between friends that travel at least part of a travel route together, such as walking together or being in the same car for a portion of each traveler's entire travel route. While real time data can be useful, historical data can be analyzed to show multiple MCDs and people that are frequently seen together by the signal tracker (e.g., signal tracker detecting the MCDs at the same time for the same duration). This data analysis can also be useful for grouping multiple MCDs together for a common person that has the multiple MCDs, such as a person with two phones, a phone and tablet, or any other combination of signal emitting devices that can be considered to be MCDs. When multiple MCDs are grouped to a single person, the Wi-Fi, BT, and cellular signals may be grouped to a person instead of being counted as different people. Such data processing can increase the accuracy of the data analytics.

In addition to the data processing determining MCD associations with a common person, the MCD data can be processed to distinguish between different types of people. This may include distinguishing between residents, visitors, workers, shoppers, or any other group of people. This information can be used for economic development and tourism, such as for targeted advertising to the groups of people. For example, residents may be targeted with different advertisements from visitors, and workers can be targeted with different advertisements from shoppers.

The data processing can be used to implement city wide (e.g., metro area or any geographic area) traffic calculations. The data processing can be used to determine optimal traffic light timing patterns for certain traffic patterns and traffic flows. This optimal traffic light timings can be updated daily, hourly, or even every minute or shorter period to improve total traffic flow for a particular road, or route, of combinations such as for multiple roads with intersections, and for cross-traffic. Such data processing can be based on historical data and real time data that shows current traffic patterns and trends. The timeframe for the optimized traffic light timings can be specific to that day of week (e.g., weekday, Monday, Tuesday, Wednesday, Thursday, Friday, weekend, Saturday, Sunday), holiday or pre-holiday traffic (e.g., New Year's, Easter, Mother's Day, Father's Day, Memorial Day, Independence Day, state holidays, Labor Day, Thanksgiving, and Christmas), or even specific days of the year. The data processing can allow for a municipality or other entity that controls traffic lights and patterns to create pre-calculated traffic light responses to real time traffic surges based on historical data, which can set new timing light sequences until the real time traffic surge subsides.

In one embodiment, the travel data can be combined with weather data. This can allow for making determinations based on like weather conditions, and omitting or filtering out different weather conditions compared to the weather of a target timeframe. This allows for matching travel data with weather data. This can improve the analysis so that similar conditions for a travel route or traffic pattern can be compared together. For example, traveling in the summer sun is significantly different from traveling in winter snow, and modulations of the data analysis with weather conditions can improve all aspects of the data processing, such as for traffic control or targeted advertising. This can allow for changing traffic light patterns based on the weather. For example, snowy conditions may need a slower travel rate in certain travel areas, and dry conditions can use a faster travel rate in the same travel areas.

The traffic system can be used for monitoring the movement of vehicles on the traffic grid, and optimizing traffic light signaling patterns to minimize traffic congestion based on current traffic volume and conditions (e.g., real time traffic data) and optionally also based on historical travel volume and conditions (e.g., historical traffic data). The traffic lights can be set to control the flow of traffic (e.g., stop or go) based on traffic data collected from vehicles and/or their drivers in real-time and communicated to the SCS for calculation of optimal traffic light signaling sequences and patterns. The traffic lights can be equipped with proximity signal trackers (e.g., signal trackers 104) which collect and transmit data from vehicles passing nearby for computation into an optimal traffic light pattern that will be implemented for the current traffic speed and volume. The traffic lights may be controlled by a computing system, such as the SCS or from data provided by the SCS. The traffic lights may not have a signal tracker; however, the signal trackers may be included in areas in close proximity to the traffic lights so as to be associated therewith. The traffic system can be used for monitoring and managing traffic congestion by modulating traffic light patterns in real-time by processing travel data for the vehicles in the traffic. The travel data for a vehicle can be provided from GPS data for the vehicles or MCDs associated with the vehicle, and the travel data can be collected by the signal trackers to map the current traffic conditions and compute an optimal traffic light pattern to minimize traffic congestion. The system can utilize a central server (or group of servers) configured as the SCS that receives the travel data (e.g., GPS data and/or signal tracker data), and compute an optimal traffic light pattern that is communicated to the traffic light controls for implementing the pattern. The traffic light pattern can include the traffic lights showing green lights in a through mute and red lights in a cross mute. The traffic light patterns can be for one or more traffic lights, and may identify the timing of the green lights, yellow lights, and red lights for the different directions of an intersection. The travel data can be collected by the traffic system from signals emitted from a wireless device (e.g., MCD) or transceiver associated with the vehicle or its occupant(s). The wireless devices can be MCDs, such as a standard smartphone, tablet, or similar portable devices. In addition to the signal trackers communicating with the SCS, the MCDs can be provided with software adapted to facilitate the MCD communicating through the network or proximity nodes to the SCS. The SCS computes an optimal traffic light pattern and communicates the optimal traffic light pattern with the traffic light control system to implement the optimal traffic light pattern that was computed.

The signal tracker technology can be configured to operate as proximity nodes, and can include Bluetooth iSignal trackers, or similar “smart signal tracker” technology available from Estimote, GeLo, or similar companies. As will be appreciated by one of ordinary skill in the art, any suitable proximity signal technology is deemed within the scope of the invention, such as Wi-Fi, cellular, or other. The signal trackers can be configured to receive a signal from a mobile device to indicate the user is within a permissible distance of the node to send and receive data with the signal tracker. Preferably, the signal trackers are equipped with encryption technology so secure information can be communicated to an SCS for further processing. Also, the signal trackers can be designed for the specific purpose of collecting vehicle information (e.g., MCD information) and communicating it to the system for computation of an optimal traffic light pattern based on current conditions in near real-time as well as historical conditions.

In one embodiment, the vehicle data is collected by the traffic system by the signal trackers communicating with wireless devices (e.g., MCDs) associated with the vehicle or its occupant(s) through specialized software. The specialized software preferably allows the vehicle data to be unique to each wireless device and allows the traffic system to track each vehicle or individual wireless device throughout its movement in the traffic system. As will be appreciated, individual as opposed to aggregate or generic traffic data may be used by the system to track and calculate the actual flow of vehicular traffic. The software may comprise a “Smart Phone App” or similar software application that is downloadable by the wireless device user, and which may allow a user to opt-in to provide additional information to the traffic system. Such additional information can be any information that the wireless device can provide in addition to the Wi-Fi signal data (e.g., MAC data, etc.), Bluetooth signal data, and/or cellular signal data. Such additional information may be GPS data, or personal data, as well as any data the user chooses to provide via the application. The software can be configured to include user features in addition to vehicle tracking that make the application more appealing to commuters as well as providing opportunities of generating revenue by the entity that provides the application to the user.

While generally controlling traffic flow through and between intersections, the traffic system can be configured with the ability to control traffic light signaling for priority vehicles, such as EMS, ambulances, fire trucks, VIPs, etc., to expedite their arrival time in emergency situations. The traffic system also has the ability to track data over time to identify traffic trends and patterns based on time of day, time of year, weather conditions, events, or any other travel timeframe to use predictive analytics to optimize traffic light signaling to achieve traffic efficiencies and keep traffic moving at a desired rate.

The term “central server” or “SCS” should not be construed to limit the scope of the invention to any type, number, or configuration of computers, servers, networks, or systems having one or more of the same. The term is used generically to refer to any device, database, machine-readable memory, central authority, or system that is capable of providing the functionality described herein.

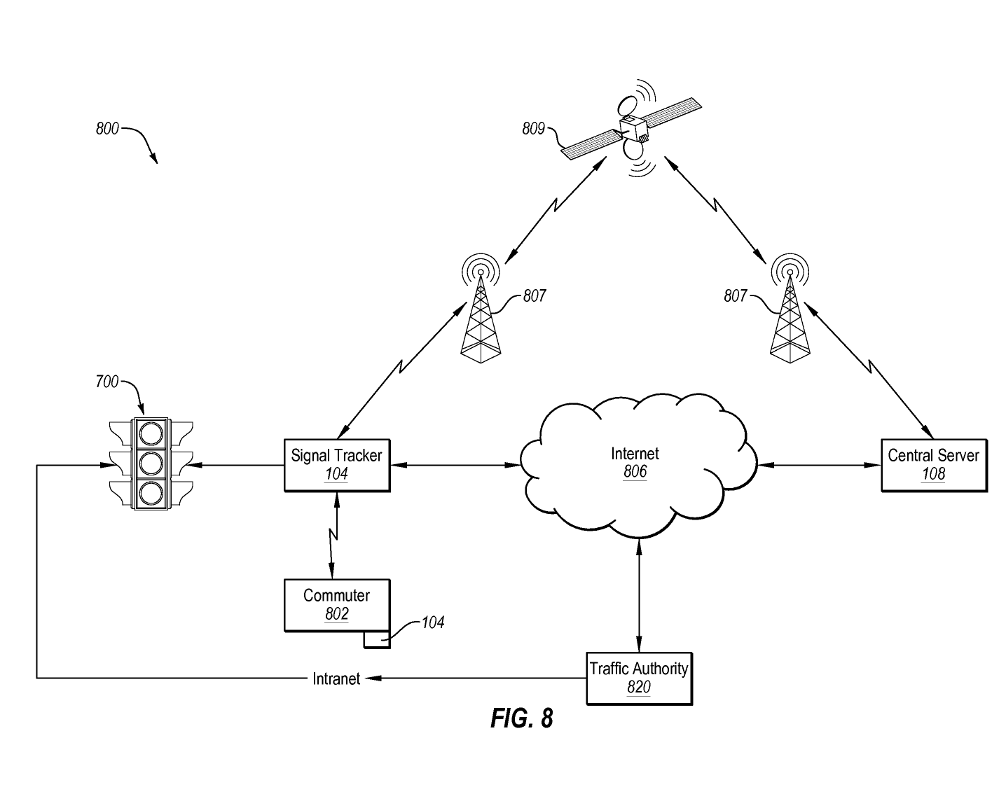

An embodiment of the traffic system 800 is depicted in FIG. 8. As represented, the system 800 includes a plurality of commuters 802 having wireless communication devices (e.g., MCDs 104). The MCDs 104 can wirelessly receive and transmit data through a communications network 806 populated with cell towers 807 and satellites 809 or other network means that allow MCDs 104 to transfer data to and from the SCS or with other MCDs over the world wide web or Internet or ad hoc network or any other network.

GPS data broadcast by a network of global positioning satellites 809 allows an MCD to identify its position on the Earth and transpose that location onto a map which includes roads. The ever-changing GPS location of a moving vehicle may be used by the traffic system to identify the vehicle speed of the commuter (e.g., MCD) as it travels along roadways. The vehicle's speed, stops, and chokepoints are communicated to the SCS 108.

The SCS 108 can be configured to obtain the vehicle data of a plurality of vehicles (e.g., commuters 802 or MCDs 102) travelling the roadways to determine rates of speed, averages, and collective travelling information. The SCS 108 is also configured with a database of traffic lights 700 existing along the various roadways. The SCS 108 is then able to use predictive analytics to calculate differing traffic light patterns and their probable effect on the various vehicles travelling on the roadways and street grids. An optimum traffic light pattern can be selected and communicated to the traffic lights 700. In operation, the traffic lights 700 execute the traffic light pattern as instructed. As additional vehicles travel along the roadways, additional vehicle data is collected and the SCS in turn continues to calculate optimum traffic light patterns to optimize traffic flow in real time based on real time traffic data and optionally based also on historical traffic data.

In one embodiment, the traffic lights 700 can be equipped with proximity signal trackers 104 or be associated with signal trackers 104 placed near the traffic lights 700. The signal trackers 104 are preferably devices that receive signals emitted from MCDs 102 where such signals can be infrared, radio, or similar signals that do not require the transmission of information through the Internet or other WAN. The signal trackers 104 can be operated to confirm that an MCD is within the geographic area of the traffic light 102 to which the signal tracker 104 is associated. Once too far removed from the proximity of a signal tracker 104 (e.g., signal tracker zone), the communication link is lost, and the MCD 102 can no longer communicate with that specific signal tracker 104; however, another signal tracker 104 along the travel route can then detect the MCD 102. The signal trackers 104 can take the vehicle data they receive from passing vehicles (e.g., MCDs 802 in vehicles) and communicate the data to the SCS 108. The SCS 108 then uses data received from a plurality of signal trackers 104 disposed throughout the traffic network to determine the current flow of traffic and then compute an optimum traffic light signal pattern to optimize vehicle flow through the monitored roadways.

In municipalities wherein the traffic lights 700 of the traffic grid are controlled via any network connection such as wireless or intranet connection, the traffic system 800 can interface with the traffic authority servers 820 to communicate an optimal traffic light signal pattern, which is then carried out through the commands communicated from the traffic authority to the individual traffic lights. The data for traffic light management can be provided with encryption. The traffic patterns can be programed or authorized to be processed by a user, by imputing information into the computing system (e.g., SCS 108).

The traffic system can be sufficiently operated for the functions described herein by detecting passive signals from the MCD, such as cellular, Wi-Fi, and Bluetooth. However, the system can additionally use data collected from the GPS feature of a MCD. By using both sources of data, a more complete picture of the traffic grid can be developed and accounted for by the SCS. Additionally, signal trackers are not susceptible to the variances in geographic accuracy that can be associated with GPS receiving devices. With this configuration, the cellular transmission capability of the MCD is unnecessary for the operation of the system.

Also, the MCDs and signal trackers can be configured with two way communications so that the signal tracker can receive data and transmit data with the MCD, and the MCD can receive data and transmit the data with the signal tracker. The data can be any type of data, and the data can change so allow for information and traffic conditions to be provided between the MCD and signal tracker, and allow for driving instructions to be provide to the MCD based on the central server. The travel data can be provided to the MCD and the MCD can provide the travel data to the vehicle so that the vehicle can operate according to the travel data. A commuter may receive the travel data and implement driving in view of the travel data and driving instructions. A self-driving vehicle may receive the travel data and implement driving instructions to drive the vehicle in accordance with the travel data and driving instructions.

The signal trackers may be customized to provide additional advantageous features. In accordance with one embodiment, an advantageous feature is that the signal trackers are configured to provide traffic light control of the traffic lights to which they are associated. Accordingly, the signal trackers can receive a computed optimal traffic light pattern from the SCS and then control the execution of the traffic light pattern on their associated traffic light.

Also, the signal trackers can be interconnected to one another by having transceivers and communicate with one or more servers (e.g., SCS) interconnected in the network. The server(s) then use the collective vehicle data received from the signal trackers and computes an optimal traffic signal pattern. The signal trackers and traffic lights may be grouped in clusters that are each responsible for computing optimal traffic patterns for their portion, or cluster, of the overall traffic grid.

In municipalities wherein the traffic lights of the traffic grid are controlled via any network connection such as wireless or intranet connection, the traffic system can interface with the traffic authority servers to communicate an optimal traffic light signal pattern, which is then carried out through the commands communicated from the traffic authority to the individual traffic lights. The data for traffic light management can be provided with encryption.

Each MCD communicating with the signal trackers can have a unique signature or identification. That allows the traffic system to track the progress of individual vehicles throughout the traffic grid to not only determine average speed but also track individualized commuting trends. The uniqueness of users also allows the traffic system to identify priority users and control traffic lights accordingly. For example, if an emergency vehicle operator's MCD passes within the footprint of a signal tracker, the signal tracker can detect the MCD and communicate such detection with the SCS, which can transmit a traffic light signaling pattern to the traffic lights that expedites the passage of the emergency vehicle through the traffic lights.

The application on an MCD can provides a platform for targeted information pushing (e.g., traffic data and alerts), custom reporting, and other features for the individual subscribers. Once deployed on a smart phone, the application can be used as a complete, and customizable, set of travel information in one place, from weather, to travel times, to alternate routes, to locations of police vehicles, or other information to improve a travel experience. The application can entice and encourage users to utilize their personally relevant and useful information while providing a more synchronized traffic grid and personally targeted traffic information. The application may also suggest traffic routes based on previous trends and current conditions, such as traffic flow, travel time, construction, accidents, or other occurrences on a roadway that impacts travel.

Additionally, the application on an MCD can be used to collect data regarding movement of the MCD, such as through gyroscope data, accelerometer data, pressure data, or any other data can be obtained regarding the status of the MCD. Such data can provide information for what the owner of the MCD is doing. For example, the gyroscope may provide data about the body movement, which may indicate climbing stairs compared to an elevator. Accelerometer data can be used to determine changes in direction. Pressure data may be used to indicate whether or not the MCD is on a person getting into or out of a car.

The traffic system can include any number of signal trackers in any distribution or density with signal tracker zones being separate or overlapping. Additional signal trackers allow for more detection probability of an MCD. Additionally, the traffic system can provide information through the application that allows users (e.g., travelers) to see the number of other travelers in an area or along travel route to get an idea of the traffic congestion. The traffic system will also be able to allow users of the application to find the physical location of other users on the system.

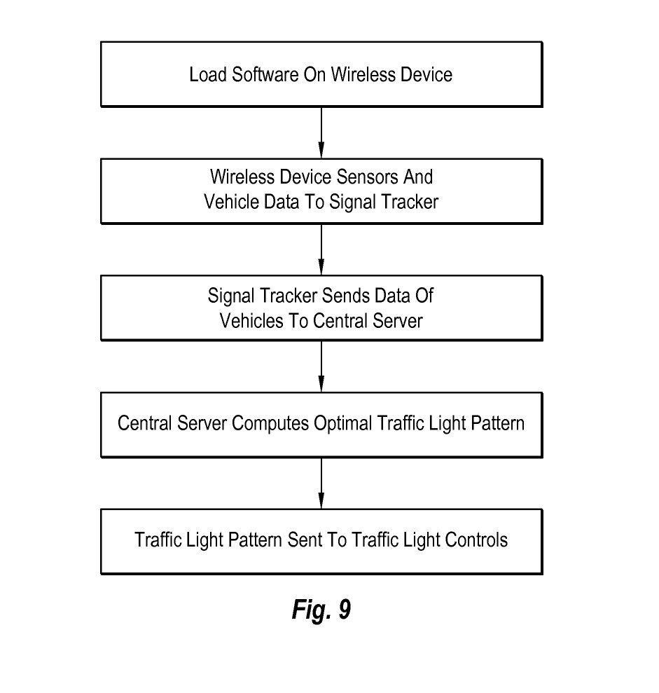

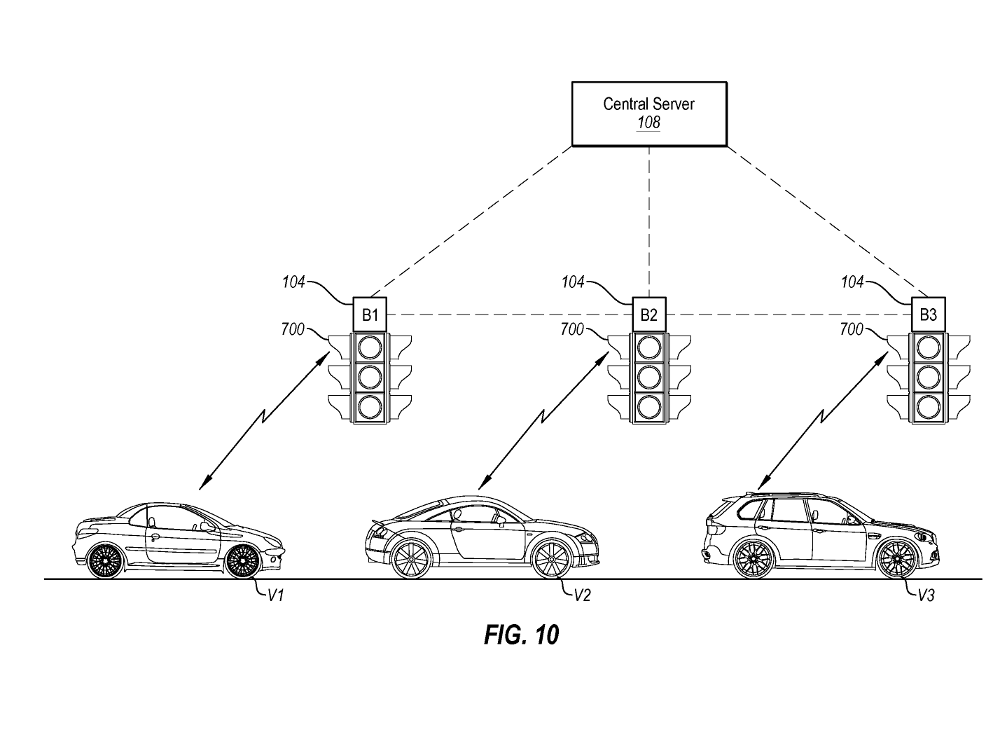

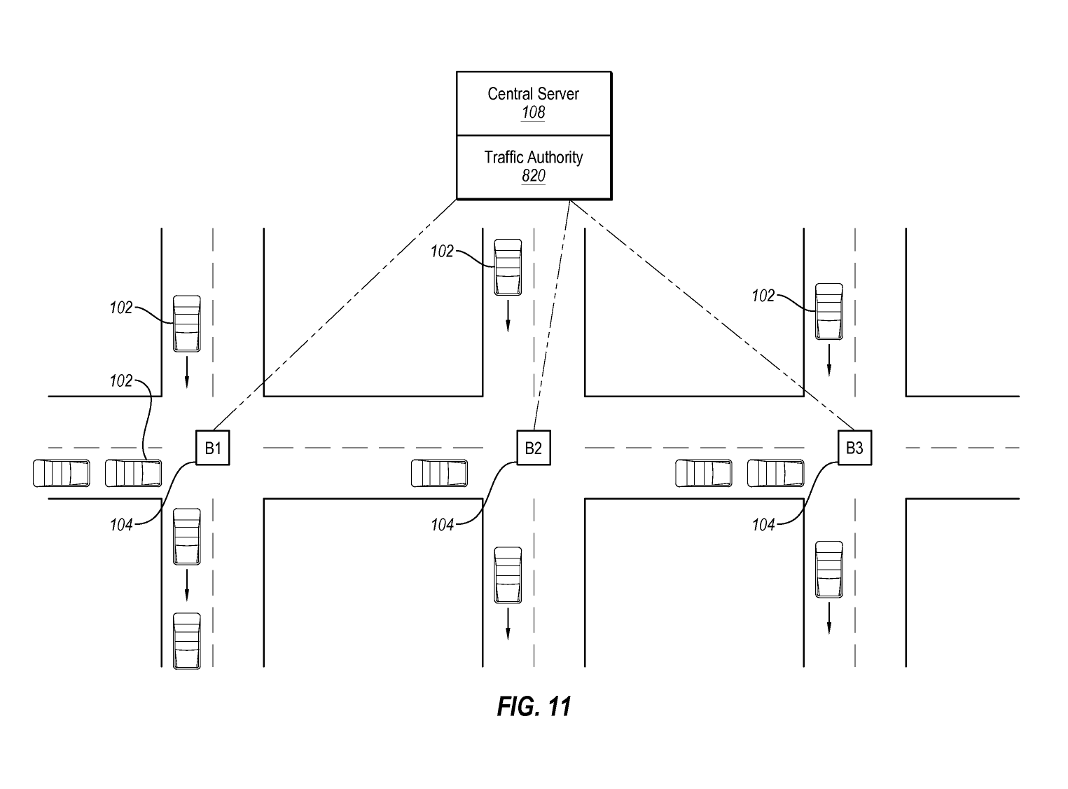

As broadly depicted in the steps of the flow-diagram of FIG. 9 and shown in FIGS. 10 and 11, an embodiment of the traffic system includes a plurality of MCDs 102 in different vehicles (e.g., V1, V2, V3) emitting signals that are detected by nearby signal trackers 104, and the signal trackers 104 collect data from these signals. The signal trackers 104 transmit the data to the SCS 108. As commuters pass additional signal trackers 104 at various locations, that traffic data is communicated to the SCS 108. Based on the aggregate of data collected from signal trackers 104 in an area, the SCS 108 computes an optimal traffic light signal pattern. The traffic light pattern can be approved by a user and authorization can be input into the SCS by the user. The pattern is then communicated to the traffic light controls via a traffic authority intranet or through signal tracker controls. The traffic lights 700 adopt the pattern and the associated signal trackers 104 continue to monitor and report traffic data to the SCS 108 for additional analysis of the optimal traffic light pattern. The system is a dynamic system that is constantly taking in and analyzing commuter data.

In an example, a traffic system for monitoring and managing traffic flow can include: a plurality of traffic lights; a traffic light controller for controlling the light signal pattern of said plurality of traffic lights; a plurality of signal trackers, one of said signal trackers being associated with a respective one of said traffic lights; an MCD comprising a memory including machine-readable software configured to cause the emission of signals having data to each of said signal trackers when within an operative area of said signal tracker; an SCS configured to receive information from said plurality of signal trackers and compute an optimal traffic light pattern based on the data. The SCS can be configured to compute an optimal traffic light signal pattern based on desired travel speeds for the collective data.

According to FIG. 9, traffic analysis methods 900 can include an optional step of loading software on a wireless device, such as an MCD. The wireless device sends data (e.g., travel data, MCD data, etc.) to a signal tracker (e.g., beacon). The signal tracker can send the data to the central server (e.g., SCS). The central server can computer an optimal traffic light pattern. The optimal traffic light pattern can be sent to the traffic light controls.

The system can be configured so that the signal trackers can communicate with the MCD by receiving data from the MCD and transmitting data to the MCD. The system may also be configured to allow the signal trackers to provide information to the MCD so that control over the mode of transit can be performed by the MCD or at least from the data from the MCD. The MCDs may use the traffic data from a signal tracker to control the mode of transits navigation and routing, as well as speed, acceleration, deceleration, stopping and response to traffic signals.

In one embodiment, the signal trackers can include transceivers that can be embedded in a traffic light. However, such use of a signal tracker including a transceiver may potentially also be useful to the other signal tracker installation stations, such as traffic lights, street lights, power poles, stand-alone units, and boxes attached to stationary objects. This can be performed when the signal trackers have transceivers that can communicate by transmission and reception of data with a MCD connected vehicle. The data can tell the MCD the color of a traffic light, and when the tight changes. The data may also provide a countdown of the traffic light change so that the MCD can provide the data to the mode of transportation to optimize starting, stopping, or traversing the traffic light. In one aspect, this configuration and communication can serve to provide data to autonomous vehicles so that the autonomous vehicle can know if the light is red, green, yellow, as well as the traffic color change pattern and light durations. This can allow for the autonomous vehicle to selectively accelerate, decelerate, stop, or maintain speed through a traffic intersection having the traffic light.

Similarly, the signal trackers can be used to provide traffic information for a specific location or route to vehicles passing by, whether autonomous or human operated. The driver (e.g., human or computer) can then use the traffic information to change or maintain their driving style and routes.

The signal tracker can provide data from the network that can allow self-driving vehicles (e.g., autonomous vehicles) to know what type of traffic is in the area. The signal trackers can provide data so that the vehicles knows what other vehicles are around them, and the proximity of the other vehicles. The data may also the system to collaboratively determine the driving characteristic of one or more vehicles, and provide the data to the vehicle so that the vehicle can drive according to a specific driving characteristic. The data may be determined from the signal trackers collecting data from the MCDs around them because the signal tracker can detect signals from MCDs in cars, and the MCDs can interface with self-driving vehicle through our system.

The signal tracker networks and network data can allow self-driving vehicles to know what is going on around them as each vehicle can detect signals in other vehicles. This allows each vehicle to interface with other self-driving vehicles throughout the system.

In one embodiment, the computing systems of the network can process data to identify the location of a MCD. The system can use trilateration or trilateration with two, or three or more signal trackers to essentially triangulate or trilaterate a position of each vehicle. This can be helpful to human or computer driven vehicles.

In one embodiment, the system includes a data packaging platform. The data packaging platform can include a computing system that can either retain data or can access the data collected from the systems and networks described herein. The data can be analyzed so that the owner of a MCD can be classified. The classifications can be group together into defined groups. The data packaging platform can then receive a data request for a certain characteristic, such as from an entity such as an advertiser or data analyzer. The data packing platform can respond to the request by providing data for one or more groups having the characteristic to the entity. The entity then can either interface with the data packaging platform or use their own data analytic software to reanalyze, reclassify, and repackage the data based on selected parameters. The entity can then interface with the data packaging platform to provide discrete data packages of data of MCD owners with defined characteristics. The entity can sell the discrete data packages through the data packaging platform. This will provide a platform where other companies can purchase the data produced or generated by the system, repackage the data, and sell the repackaged data through the platform to provide more valuable data having certain classifications to specific niches.

In one embodiment, a method for classification of non-moving devices is provided that allows the systems to determine MCD devices or other devices that emit signals as stationary and non-moving. The method can include a signal tracker detecting a specific MCD for a long duration, such as up to 24 hours. The system can obtain data, which is encoded as an array of bits with length 24, which represents the hours a single MCD was seen by a single signal tracker in the last 24 hours. This data is stored as a single 24 bit value in a remote key/value store. When a single MCD is observed the value is retrieved, the current hour is set to 1 and any hours since the last time it was seen are set to 0. The sum of these 24 bits corresponds to the number of hours a single signal tracker has been detected the single MCD in the past 24 hours. The MCD can then be classified as non-moving if it is consistently seen (e.g., for example 13 or more hours) by the same signal tracker over the last 24 hours. This classification can then be used to modify data upload and processing methodology on the server and sent to the signal tracker to modify how data on a particular MCD is filtered before reaching the server.

Also, the system can determine that a single MCD is present at a signal tracker for a defined period of time without leaving the area of the signal tracker. When the system encounters a long period of detection of a specific MCD by a specific signal tracker, that MCD can be tagged as non-moving and the MCD signals can be discarded. Also, an MCD classified as non-moving can filtered from the MCD data of the signal tracker so that is either discarded at the signal tracker or system.

Additionally, the system can log all non-moving MCD and save the identifier information for the non-moving MCD. This allows the system to retrieve non-moving MCD data to filter all MCD data to remove all data regarding the non-moving MCD.

In one embodiment, the system can process methods for classification of a single person that has multiple devices. The method includes obtaining data (e.g., step 1) from a specific timeframe (day, month, etc.) for a specific MCD from one or more signal trackers. Analyzing the data of all MCDs time and location (e.g., signal tracker ID) and determining whether two or more MCDs are seen at the same time and location at two or more defined times and locations. The system can compute (e.g., step 2) the number of times two or more MCD identifiers are seen together at the same location and times, which can include an analysis on the specific time intervals (e.g., 1 minute) by the same signal tracker. The system can then compute (e.g., step 3) the overall number of intervals either MDC identifier was seen, and then perform the same computation (e.g., step 4) for each MCD identifier pair or triplet, or more, which may be from a person having a combination of devices, such as smart phone, tablet, personal computer, and any other, each of which has a unique MCD identifier. Step 4 can include dividing the result in step 2 by step 3 to get a percentage of time that these MCDs travel together. MCDs frequently seen together and rarely seen apart can be classified as the same person, and this classification can be used for analytics on the number of people (not just MCDs) which were in a given location. The same calculation can be performed to determine the frequency the specific MCDs are seen together and frequency the specific MCDs are seen apart. High frequency togetherness with low separation indicates the MCDs are carried by the same person. High frequency togetherness with significant separation indicates the MCDs are carried by people that are traveling together. Also, smaller or variable timeframes may be used to classify groups of people who travel together (e.g., carpool, bus, etc.) for specific periods and then separate. The times of togetherness compared with normal social routines can be used to group people as strangers that travel together the separate in a routine, and group people as acquaintances that travel together and spend time at the same location together in a routine.

In one embodiment, the systems and methods can be used for classification of Workers/Residents/Visitors to a specific area. The system can obtain the data from signal trackers and transfer it to the central server system, and the multiple observations of each MCD by each signal tracker is summarized (in a separate database table) as an arrival and departure time for that MCD and that signal tracker. The system by using this information can calculate various parameters from a given specific area (e.g., defined by a group of signal trackers): a. Monthly visitation (e.g., specific days and number of days seen); b. Average daily arrival and departure time; c. Type of days generally seen (weekdays/weekends); and d. Road types used (e.g., primarily large roadways or back roads/shortcuts or specific routine combinations) based on signal tracker location. The system by using the above information can determine multiple classifications of people, such as for example: a. Worker: Frequently seen weekdays, arrives on average between 8 AM and 10 AM and departs between 4 PM and 6 PM; Resident: Very high monthly visitation, and frequently uses at least some back roads; or Visitor: Low monthly visitation, frequently seen weekends, rarely uses back roads and mainly uses main roads. The MCD or person, using methods above, can then be classified as a worker, resident, visitor, etc. to a specific area defined by a group of signal trackers. The classification data and related information can be used to segregate classifications and classifications of other analytic results into defined groups for a target audience. The target audience can be tailored to obtain specific data for advertisers, municipalities, or businesses would be interested in targeting certain classifications of people.

In one embodiment, a signal tracker can include: a housing; at least two signal detectors in the housing; a computing component in the housing and operably coupled with the at least two signal detectors so as to obtain signal data therefrom; a memory device in the housing communicatively coupled with the computing component so as to receive the signal data and store the signal data thereon; and a transmitter in the housing communicatively coupled with the computing component so as to be capable of transmitting the signal data to a network. The signal tracker can include one or more of the following components: a connector port; a cooling element; a heating element; a thermostat; a thermocouple; a power source; a wind turbine; or a solar panel. The signal tracker can include one or more of the following components: an SPI module; an I2C module; a USB port; an Ethernet port; a MURS radio; a cellular module; a flash memory device; a RAM memory device; a Bluetooth module; a Wi-Fi module; a microprocessor; a wireless transmitter; an electronic plug; or a receiver. The signal tracker can include all of the listed components. The signal tracker can include the housing being a weatherproof housing. The signal tracker can include the at least two signal detectors being selected from the group consisting of a cellular detector, a Wi-Fi detector, or a Bluetooth detector. The signal tracker can include a receiver in the housing communicatively coupled with the computing component so as to be capable of receiving data from a network.

In one embodiment, a traffic light can include: at least one light emitter that is configured to emit a traffic signal light; and the signal tracker of one of the embodiments, the at least one light emitter being in the housing and having the light emitter directed out of the housing to emit traffic signal light. The at least one light emitter includes one or more of: a red light emitter, yellow light emitter, and a green light emitter; a computing component configured to execute a traffic light pattern with the at least one light emitter; or a receiver that is configured to receive traffic light pattern data from a traffic light controller. The traffic light can include: an electronic component having a first electronic coupling member; and the signal tracker having a second electronic coupling member that removably couples with the first electronic coupling member.

In one embodiment, a street light can include: at least one light emitter that is configured to emit illuminating light; and the signal tracker of one of the embodiments, the at least one light emitter being in the housing and having the light emitter directed out of the housing to emit illuminating light.

In one embodiment, a cross-walk light can include: at least one light emitter that is configured to emit a cross-walk signal light; and the signal tracker of one of the embodiments, the at least one light emitter being in the housing and having the light emitter directed out of the housing to emit cross-walk light.

In one embodiment, a traffic light can include: a display screen that is configured to emit traffic signal information as a light image; a computer processor operably coupled with the display screen so as to provide the traffic signal information; a memory device operably coupled with the computer processor and having computer-executable code for causing the display screen to display traffic control information; and the signal tracker of claim 1 operably coupled with the computer processor, the display screen being in the housing to emit the traffic signal information out of the housing, the computer processor and memory device in the housing. The traffic light can include a receiver that is configured to receive traffic light pattern data from a traffic light controller. The traffic light can include an electronic component having a first electronic coupling member in the housing; and the signal tracker having a second electronic coupling member that removably couples with the first electronic coupling member. The traffic light can include a plurality of display screens, each being configured to emit traffic signal information as a light image.

In one embodiment, a traffic modulation system can include: a plurality of signal trackers of one of the embodiments; a server computing system communicatively coupled to the plurality of signal trackers through a network; a plurality of traffic lights; and a traffic light controller communicatively coupled with the server computing system and the plurality of traffic lights so that the traffic light controller can receive traffic light pattern data from the server computing system and implement the traffic light pattern data to modulate the traffic light pattern of the plurality of traffic lights. The server computing system can have a memory device with computer-executable code for receiving traffic data from the plurality of signal trackers and processing the traffic data to determine traffic light pattern data. In one aspect, the signal trackers are configured as described herein. In one aspect, the server computing system has components of a computer, including a transceiver, a memory device, a processor, and a traffic analytic module. In one aspect, the server computing system has a memory device with computer-executable code for receiving traffic data from the plurality of signal trackers and processing the data to determine traffic light pattern data.

In one embodiment, a traffic light can include: at least one light emitter that is configured to emit a traffic signal light; and a signal tracker. In one aspect, the at least one light emitter includes a red light emitter, yellow light emitter, and a green light emitter. In one aspect, the at least one light emitter and signal tracker are included in a housing. In one aspect, the signal tracker is integrated in the traffic light. In one aspect, the signal tracker is coupled with the traffic light. In one aspect, the traffic light can include a computing component configured to execute a traffic light pattern with the at least one light emitter. In one aspect, the traffic light can include a receiver that is configured to receive traffic light pattern data from a traffic light controller. In one aspect, the traffic light can include an electronic component having a first electronic coupling member; and the signal tracker having a second electronic coupling member that removably couples with the first electronic coupling member.

In one embodiment, a street light can include: at least one light emitter that is configured to emit light; and a signal tracker. In one aspect, the at least one light emitter emits light to illuminate a street. In one aspect, the at least one light emitter and signal tracker are included in a housing. In one aspect, the signal tracker is integrated in the street light. In one aspect, the signal tracker is coupled with the street light. In one aspect, an electronic component having a first electronic coupling member; and the signal tracker having a second electronic coupling member that removably couples with the first electronic coupling member.

In one embodiment, a cross-walk light can include: at least one light emitter that is configured to emit a cross-walk signal light; and a signal tracker. In one aspect, the at least one light emitter is configured to emit light to indicate it is safe to cross the cross-walk or it is not safe to cross the cross-walk. In one aspect, the at least one light emitter and signal tracker are included in a housing. In one aspect, the signal tracker is integrated in the cross-walk light. In one aspect, the signal tracker is coupled with the cross-walk light. In one aspect, the cross-walk light can include a computing component configured to execute a cross-walk light pattern with the at least one light emitter. In one aspect, the cross-walk light can include a receiver that is configured to receive cross-walk light pattern data from a traffic light controller that can control the cross-walk light. In one aspect, the cross-walk light can include: an electronic component having a first electronic coupling member; and the signal tracker having a second electronic coupling member that removably couples with the first electronic coupling member.

In one embodiment, a traffic light can include: a display screen that is configured to emit traffic signal information as light; a computer processor operably coupled with the display screen so as to provide the traffic signal information; and a memory device operably coupled with the computer processor and having computer-executable code for causing the display screen to display traffic control information. In one aspect, the traffic light can include a weatherproof housing having the display screen as an outside surface and containing the computer processor and memory device therein.

The traffic light can include one or more of the following components: a connector port; a cooling element; a heating element; a thermostat; a thermocouple; a power source; a wind turbine; or a solar panel. The traffic light can include one or more of the following components: an SPI module; an I2C module; a USB port; an Ethernet port; a MURS radio; a cellular module; a flash memory device; a RAM memory device; a Bluetooth module; a Wi-Fi module; a microprocessor; a wireless transmitter; an electronic plug; or a receiver. The traffic light can include all of the listed components. The traffic light can include an embodiment of a signal tracker. In one aspect, the signal tracker is integrated in the traffic light. In one aspect, the signal tracker is coupled with the traffic light. The traffic light can include a receiver that is configured to receive traffic light pattern data from a traffic light controller. The traffic light can include: an electronic component having a first electronic coupling member; and the signal tracker having a second electronic coupling member that removably couples with the first electronic coupling member.

In one embodiment, a method of modulating traffic can include: detecting a signal of one or more mobile computing devices (MCDs) at a first location with a first signal tracker; obtaining real time travel data about the one or more MCDs from the signal received by the first signal tracker; determining a traffic volume at the first signal tracker; comparing the traffic volume with a traffic volume threshold; if the traffic volume is lower than the traffic volume threshold, a traffic light at the first location maintains a first traffic light pattern; and if the traffic volume is higher than the traffic volume threshold, a traffic light at the first location changes to a second traffic light pattern. In one aspect, the traffic volume can be in at least one direction at an intersection. In one aspect, the traffic volume threshold is for a defined time frame. The method can include lessening the traffic volume at the first location with the second traffic light pattern. The method can include modulating the traffic light pattern in at least one direction so as to increase traffic flow past the first location in the at least one direction and to reduce traffic flow past the first location in a cross-direction. In one aspect, the second traffic light pattern can include lengthening a green light in a first direction and lengthening a red light in a second direction that is a cross-direction from the first direction. The method can include determining a traffic light pattern for two or more consecutive lights in a travel route in order to increase traffic flow past signal trackers associated with these two or more consecutive lights.

In one embodiment, the traffic analytic methods can include: determining an estimated travel time from the first location to a second location that has a second signal tracker; determining an optimized traffic light pattern to reduce the estimated travel time from the first location to the second location; and modulating one or more travel lights between the first location and second location with the optimized traffic light pattern so as to reduce the actual travel time from the first location to the second location.

In one embodiment, the traffic analytic methods can include: accessing a database having historical travel data for the first MCD; comparing the historical travel data with the real time travel data for the first MCD to determine travel data for the first MCD; analyzing the travel data for the first MCD with other MCDs; determining one or more travel data groups; and grouping the first MCD with one or more other MCDs into one or more data groups.

In one embodiment, the traffic analytic methods can include: determining a mode of travel of the first MCD; predicting a travel route for the first MCD; or predicting a time of travel for the first MCD on the predicted travel route to a second signal tracker.

The methods can include: detecting a signal of a second MCD at the first location with the first signal tracker; and obtaining real time travel data about the second MCD from the signal received by the first signal tracker.

The methods can include: determining a mode of travel of the second MCD; and if the mode of travel of the second MCD is the same as the first MCD, the first MCD and second MCD are grouped into a first travel mode group, if the mode of travel of the second MCD is different from the first MCD, the first MCD is grouped into a first travel mode group and the second MCD is grouped into a second travel mode group.

The methods can include: predicting a travel route for the second MCD; if the travel route for the second MCD is the same as the first MCD, the first MCD and second MCD are grouped into a first travel route group, if the travel route for the second MCD is different from the first MCD, the first MCD is grouped into a first travel route group and the second MCD is grouped into a second travel route group.

The methods can include: predicting a time of travel for the second MCD on the predicted travel route to a second signal tracker; and if the time of travel for the second MCD is the same as the first MCD, the first MCD and second MCD are grouped into a first time of travel group, if the time of travel for the second MCD is different from the first MCD, the first MCD is grouped into a first time of travel group and the second MCD is grouped into a second time of travel group.

The methods can include: analyzing travel data for the first MCD; and predicting an origination location for the first MCD.

In one embodiment, the methods can include: analyzing travel data for the second MCD; predicting an origination location for the second MCD; and if the original location of the first MCD and the second MCD is within a first defined origination geographic area, the first MCD and second MCD are grouped into a first origination location group, if the original location of the first MCD is within a first defined origination geographic area and the original location of the second MCD is within a second defined origination geographic area, the first MCD is grouped into a first origination location group and the second MCD is grouped into a second origination location group.

The methods can include: analyzing travel data for the first MCD; and predicting a destination location for the first MCD.

In one embodiment, the methods can include: analyzing travel data for the second MCD; predicting a destination location for the second MCD; and if the destination location of the first MCD and the second MCD is within a first defined geographic area, the first MCD and second MCD are grouped into a first origin location travel group, if the original location of the first MCD is within a first defined geographic area and the original location of the second MCD is within a second defined geographic area, the first MCD is grouped into a first origin location travel group and the second MCD is grouped into a second origin location travel group.

In one embodiment, the methods can include: analyzing travel data for the first MCD; and analyzing travel data for the second MCD; if the travel data for the first MCD is the same for the second MCD, the first MCD and second MCD are assigned to a first traveler; if the travel data for the first MCD is different from the second MCD, the first MCD is assigned to a first traveler and the second MCD is assigned to a second traveler.

In any of the embodiments, the travel data being analyzed includes real time travel data. In any of the embodiments, the travel data being analyzed includes historical travel data. In any of the embodiments, the travel data being analyzed is historical travel data and real time travel data.

In one embodiment, the methods can include: determining the first MCD to be stationary or within a narrow geographical area for a predetermined time period; defining prior travel before becoming stationary as a first travel route for the first MCD; and defining travel subsequent to becoming stationary as a second travel route or the first MCD.

The methods can also include performing any of the one or more method steps with a plurality of MCDs.

In one embodiment, the methods can include filtering the travel data to distinguish between: different modes of travel being bus, train, car, bicycle, skiing, skating, or walking; different MCDs in a common vehicle; different MCDs for a common person; different people in a common vehicle; different travel routes for a person or group; different travel times for a person or group; different origination locations for a person or group; or different destination locations for a person or group.

The methods can include: determining an average travel time from a first location to a second location based on real time travel data; and/or determining a mean travel time from a first location to a second location based on real time travel data.

The methods can include: determining a plurality of travel routes from a first location to a second location; and filtering out one or more of the travel routes based on real time travel data and/or historical travel data to obtain one or more optimal travel routes; and presenting the one or more optimal travel routes to an MCD of the user.

The methods can include: determining a plurality of MCDs for the same traveler; and combining these MCDs so that the travel data thereof is only associated with one traveler.

The methods can include: determining two or more people that travel together in one or more travel routes; and maintaining the MCDs separately for these two or more people so that each traveler is defined.

The methods can include: obtaining weather data for the weather for the travel route, wherein the weather data is real time weather data or historical weather data; and processing the travel data with the weather data. In one aspect, the method can include modulating the data analysis with the weather data.

In one embodiment, the methods can include: determining a weather pattern for a target timeframe for a travel route; and determining weather for historical travel data for the target timeframe for the travel route; and filtering the travel data to remove data that is associated with a different weather pattern.

In one embodiment, the methods can include: determining a weather pattern for a target timeframe for a travel route; and determining weather for historical travel data for the target timeframe for the travel route; and filtering the travel data to retain data that is associated with a similar weather pattern to the weather pattern of the target timeframe.

In one embodiment, the methods can include: detecting at least one signal from a plurality of mobile computing devices (MCDs) at a first location with a first signal tracker; and obtaining real time travel data about the plurality of MCDs from the signal received by the first signal tracker; accessing a database having historical travel data for the plurality of MCDs; comparing the historical travel data with the real time travel data for the plurality of MCDs to determine travel data for the plurality of MCDs; analyzing the travel data for the plurality of MCDs; determining one or more travel data groups; and grouping some of the MCDs of the plurality of MCDs into one or more data groups.

In one embodiment, the method is performed with a traffic monitoring system that comprises: a plurality of signal trackers; a network communicatively coupled with the plurality of signal trackers; and a server computer system communicatively coupled with the plurality of signal trackers through the network, the server computer system having a database with historical travel data and having travel data modules for analyzing real time travel data and historical travel data.

The methods can include one or more of: measuring signal strength from the MCD with a signal tracker; measuring duration of signal detection with the signal tracker; identifying start of signal detection; identifying end of signal detection; triangulating the location of the MCD relative to one or more signal trackers; or using trilateration to determine the location of the MCD relative to one or more signal trackers.

The methods can include: recording signal data from one or more MCDs with a signal tracker and storing the signal data at the signal tracker; processing the signal data with the signal tracker to obtain processed signal data; uploading the processed signal data to the server computing system from the signal tracker; and purging the signal data and processed signal data from the signal tracker.

In one embodiment, the methods can include: recording signal data from one or more MCDs with a signal tracker and storing the signal data at the signal tracker; uploading the signal data to the server computing system from the signal tracker; and purging the signal data from the signal tracker.

In one embodiment, the methods includes: storing signal data from a plurality of MCDs on the signal tracker; uploading the signal data to the server computing system from the signal tracker in a batch upload; and purging the signal data from the signal tracker. In one aspect, the signal tracker includes a computing system with a memory device that has computer-executable code for performing the operations of the signal tracker. In one aspect, the server computing system includes a memory device that has computer-executable code for performing analytics on the travel data obtained by the signal trackers from the MCDs.

The methods can include: measuring a weather condition at a signal tracker; determining whether the temperature is too hot or too cold relative to a desired operational temperature range; and either heating or cooling the signal tracker to the desired operational temperature range. In one aspect, the determining of the temperature is performed at the signal tracker or at the server computing system.

In one aspect, the method can include: plugging a computer device into a signal tracker; and uploading software onto the signal tracker.

In one embodiment, a signal tracker system having a plurality of the signal trackers is located in one or more of: a metropolitan area; a city; a county; a rural area; a highway road system; a surface street road system; or combination thereof.

In one embodiment, the methods can include: detecting a plurality of MCDs at a signal tracker in a defined timeframe to obtain real time travel data; comparing the real time travel data at that signal tracker with historical travel data for that signal tracker; and determining traffic volume for that signal tracker at that timeframe.

The methods can include: operating a traffic monitoring system by using a plurality of signal tracker systems to detect MCDs, the plurality of signal tracker systems having systems in different metropolitan areas. The different metropolitan areas are in different cities, or the different metropolitan areas are in different states.

The methods can include: detecting initiation of a traffic pattern consistent with an event type; accessing historical traffic patterns that correspond with the event type; and determining the traffic pattern for the event type to be in progress. The methods can include providing information regarding the traffic pattern to a traffic light controller. The entity can implement a change in operation based on the traffic pattern.

In the methods, the MCD can have an application, and the method can include pushing information to the MCD based on traffic data. The pushed information can be real time traffic pattern information. Also, the pushed information can be any traffic data, travel data, other MCD data, or group data.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In one embodiment, the present methods can include aspects performed on a computing system. As such, the computing system can include a memory device that has the computer-executable instructions for performing the method. The computer-executable instructions can be part of a computer program product that includes one or more algorithms for performing any of the methods of any of the claims.

In one embodiment, any of the operations, processes, methods, or steps described herein can be implemented as computer-readable instructions stored on a computer-readable medium. The computer-readable instructions can be executed by a processor of a wide range of computing systems from desktop computing systems, portable computing systems, tablet computing systems, hand-held computing systems as well as network elements, base stations, femtocells, and/or any other computing device.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skilled in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and application programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those generally found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

FIG. 6 shows an example computing device 600 that is arranged to perform any of the computing methods described herein. In a very basic configuration 602, computing device 600 generally includes one or more processors 604 and a system memory 606. A memory bus 608 may be used for communicating between processor 604 and system memory 606.

Depending on the desired configuration, processor 604 may be of any type including but not limited to a microprocessor (μP), a microcontroller (μC), a digital signal processor (DSP), or any combination thereof. Processor 604 may include one or more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. An example memory controller 618 may also be used with processor 604, or in some implementations memory controller 618 may be an internal part of processor 604.

Depending on the desired configuration, system memory 606 may be of any type including but not limited to volatile memory (such as RAM), non-volatile memory (such as ROM, flash memory, etc.) or any combination thereof. System memory 606 may include an operating system 620, one or more applications 622, and program data 624. Application 622 may include a determination application 626 that is arranged to perform the functions as described herein including those described with respect to methods described herein. Program Data 624 may include determination information 628 that may be useful for analyzing the contamination characteristics provided by the sensor unit 240. In some embodiments, application 622 may be arranged to operate with program data 624 on operating system 620 such that the work performed by untrusted computing nodes can be verified as described herein. This described basic configuration 602 is illustrated in FIG. 6 by those components within the inner dashed line.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may generally be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that includes any of the above functions. Computing device 600 may also be implemented as a personal computer including both laptop computer and non-laptop computer configurations. The computing device 600 can also be any type of network computing device. The computing device 600 can also be an automated system as described herein.

The embodiments described herein may include the use of a special purpose or general-purpose computer including various computer hardware or software modules.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “ a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of

Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

All references recited herein are incorporated herein by specific reference in their entirety.

1. A signal tracker comprising:
a housing;
at least two signal detectors in the housing;
a computing component in the housing and operably coupled with the at least two signal detectors so as to obtain signal data therefrom;
a memory device in the housing communicatively coupled with the computing component so as to receive the signal data and store the signal data thereon; and
a transmitter in the housing communicatively coupled with the computing component so as to be capable of transmitting the signal data to a network.

2. The signal tracker of claim 1, comprising one or more of the following components:
a connector port;
a cooling element;
a heating element;
a thermostat;
a thermocouple;
a power source;
a wind turbine; or
a solar panel.

3. The signal tracker of claim 2, comprising one or more of the following components:
an SPI module;
an I2C module;
a USB port;
an Ethernet port;
a MURS radio;
a cellular module;
a flash memory device;
a RAM memory device;
a Bluetooth module;
a WiFi module;
a microprocessor;
a wireless transmitter;
an electronic plug; or
a receiver.

4. The signal tracker of claim 2, comprising all of the listed components.

5. The signal tracker of claim 3, comprising all of the listed components.

6. The signal tracker of claim 1, comprising the housing being a weatherproof housing.

7. The signal tracker of claim 1, comprising the at least two signal detectors being selected from the group consisting of a cellular detector, a Wi-Fi detector, or a Bluetooth detector.

8. The signal tracker of claim 1, comprising a receiver in the housing communicatively coupled with the computing component so as to be capable of receiving data from a network.

9. A traffic light comprising:
at least one light emitter that is configured to emit a traffic signal light; and
the signal tracker of claim 1, the at least one light emitter being in the housing and having the light emitter directed out of the housing to emit traffic signal light.

10. The traffic light of claim 9, wherein the at least one light emitter includes one or more of:
a red light emitter, yellow light emitter, and a green light emitter;
a computing component configured to execute a traffic light pattern with the at least one light emitter; or
a receiver that is configured to receive traffic light pattern data from a traffic light controller.

11. The traffic light of claim 9, comprising:
an electronic component having a first electronic coupling member; and
the signal tracker having a second electronic coupling member that removably couples with the first electronic coupling member.

12. A street light comprising:
at least one light emitter that is configured to emit illuminating light; and
the signal tracker of claim 1, the at least one light emitter being in the housing and having the light emitter directed out of the housing to emit illuminating light.

13. A cross-walk light comprising:
at least one light emitter that is configured to emit a cross-walk signal light; and
the signal tracker of claim 1, the at least one light emitter being in the housing and having the light emitter directed out of the housing to emit cross-walk light.

14. A traffic light comprising:
a display screen that is configured to emit traffic signal information as a light image;
a computer processor operably coupled with the display screen so as to provide the traffic signal information;
a memory device operably coupled with the computer processor and having computer-executable code for causing the display screen to display traffic control information; and
the signal tracker of claim 1 operably coupled with the computer processor, the display screen being in the housing to emit the traffic signal information out of the housing, the computer processor and memory device in the housing.

15. The traffic light of claim 14, comprising one or more of the following components:
a connector port;
a cooling element;
a heating element;
a thermostat;
a thermocouple;
a power source;
a wind turbine; or
a solar panel.

16. The traffic light of claim 15, comprising one or more of the following components:
an SPI module;
an I2C module;
a USB port;
an Ethernet port;
a MURS radio;
a cellular module;
a flash memory device;
a RAM memory device;
a Bluetooth module;
a Wi-Fi module;
a microprocessor;
a wireless transmitter;
an electronic plug; or
a receiver.

17. The traffic light of claim 14, comprising a receiver that is configured to receive traffic light pattern data from a traffic light controller.

18. The traffic light of claim 14, comprising:
an electronic component having a first electronic coupling member in the housing; and
the signal tracker having a second electronic coupling member that removably couples with the first electronic coupling member.

19. The traffic light of claim 14, comprising:
a plurality of display screens, each being configured to emit traffic signal information as a light image.

20. A traffic modulation system comprising:
a plurality of signal trackers of claim 1;
a server computing system communicatively coupled to the plurality of signal trackers through a network;
a plurality of traffic lights; and
a traffic light controller communicatively coupled with the server computing system and the plurality of traffic lights so that the traffic light controller can receive traffic light pattern data from the server computing system and implement the traffic light pattern data to modulate the traffic light pattern of the plurality of traffic lights.

21. The traffic modulation system of claim 20, wherein the server computing system has a memory device with computer-executable code for receiving traffic data from the plurality of signal trackers and processing the traffic data to determine traffic light pattern data.
